(19) United States
(12) Patent Application Publication
(10) Pub. No.: US 2019/0193724 A1
(43) Pub. Date: Jun. 27, 2019

(54) AUTONOMOUS VEHICLE AND CONTROLLING METHOD THEREOF

(71) Applicant: LG Electronics Inc., Seoul (KR)

(72) Inventors: Cheolmun KIM, Seoul (KR); Sungpil YANG, Seoul (KR); Jinkyo LEE, Seoul (KR); Sukhwan CHO, Seoul (KR)

(21) Appl. No.: 16/101,983

(22) Filed: Aug. 13, 2018

(30) Foreign Application Priority Data
Dec. 26, 2017 (KR) 10-2017-0179842

(51) Int. Cl. B60W 30/06; G05D 1/00; G08G 1/14; G06K 9/00

(52) U.S. Cl. CPC B60W 30/06; G05D 1/0088; G05D 2201/0213; G06K 9/00812; G08G 1/143

(57) ABSTRACT

Disclosed are an autonomous vehicle and controlling method thereof. The present invention includes an interface device, an object detecting device, a communication device, and a processor configured to control the interface device, the object detecting device, and the communication device. And, the processor is further configured to make a request for parking slot information to a server, select a specific parking slot based on the parking slot information received from the server in response to the request, receive a first level route from a current location of the autonomous vehicle to the selected specific parking slot from the server at a first timing, create a second level route based on information sensed in a sensing area of the object detecting device and the received first level route, and control the autonomous vehicle to drive to the specific parking slot based on the created second level route.

### CROSS-REFERENCE TO RELATED APPLICATIONS

Pursuant to 35 U.S.C. § 119(a), this application claims the benefit of earlier filing date and right of priority to Korean Application No. 10-2017-0179842, filed on Dec. 26, 2017, the contents of which are hereby incorporated by reference herein in their entirety.

### BACKGROUND OF THE INVENTION

### Field of the Invention

The present invention relates to an autonomous vehicle, and more particularly, to an autonomous vehicle and controlling method thereof. Although the present invention is suitable for a wide scope of applications, it is particularly suitable for setting a route based on information received from an external server.

### Discussion of the Related Art

A vehicle is a device that is moved in a direction desired by a user. A car if a representative example of the vehicle. For convenience of a user of a vehicle, various sensors, electronic devices and the like tend to be mounted in the vehicle. Particularly, ongoing efforts are actively made to study ADAS (advanced driver assistance system) for user's driving convenience. Moreover, ongoing efforts are actively made to research and develop autonomous vehicles.

Meanwhile, an autonomous vehicle receives information on a parking location and moving track of its own from an external server and is able to operate based on the received information.

However, if the autonomous vehicle operates by totally depending on the information received from the external server, it causes a problem that the autonomous vehicle is unable to actively cope with various incidents possibly occurring in a driving environment.

Therefore, it is necessary to research and develop an autonomous vehicle and controlling method thereof in order to cope with incidents actively using information sensed by sensors of the autonomous vehicle as well as information received from an external server.

### SUMMARY OF THE INVENTION

Accordingly, embodiments of the present invention are directed to a mobile terminal and controlling method thereof that substantially obviate one or more problems due to limitations and disadvantages of the related art.

One object of the present invention is to provide an autonomous vehicle controlled to be driven to a specific parking slot based on a second level route in a manner of making a request for parking slot information to a server, selecting the specific parking slot based on the paling slot information received from the server in response to the request, receiving a first level route from a current location of the autonomous vehicle to the selected specific parking slot, and creating the second level route based on information sensed within a sensing area of an object detecting device.

Technical tasks obtainable from the present invention are non-limited by the above-mentioned technical tasks. And, other unmentioned technical tasks can be clearly understood from the following description by those having ordinary skill in the technical field to which the present invention pertains.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, an autonomous vehicle according to one embodiment of the present invention may include a user interface device, an object detecting device, a communication device, and a processor configured to control the user interface device, the object detecting device, and the communication device, wherein the processor is further configured to make a request for parking slot information to a server, select a specific parking slot based on the parking slot information received from the server in response to the request, receive a first level route from a current location of the autonomous vehicle to the selected specific parking slot from the server at a first timing, create a second level route based on information sensed in a sensing area of the object detecting device and the received first level route, and control the autonomous vehicle to drive to the specific parking slot based on the created second level route.

According to an embodiment of the present invention, the first level route may be included in a communication coverage area of the communication device provided to the autonomous vehicle.

According to an embodiment of the present invention, the second level route may be included in the first level route.

According to an embodiment of the present invention, if detecting an obstacle, the processor may determine whether to create a branch point based on a location of the detected obstacle.

According to an embodiment of the present invention, if detecting that the obstacle enters the first level route in the sensing area through the object detecting device, the processor may not create the branch point.

According to an embodiment of the present invention, if detecting that the obstacle enters the second level route in the sensing area through the object detecting device, the processor may create the branch point.

According to an embodiment of the present invention, the processor may create a route included in the first level route in a manner of setting a start location to the branch point and also setting an end location to a point at which the autonomous vehicle joins the second level route again.

According to an embodiment of the present invention, the processor may receive the first level route at a second timing and create the second level route based on the first level route received at the second timing.

According to an embodiment of the present invention, through the communication device, if receiving information indicating that the obstacle enters the second level route in the communication coverage area from the server, the processor may send information on at least one of a current location of the autonomous vehicle, the first level route and the second level route to the obstacle using communication with the server.

According to an embodiment of the present invention, the second timing may be different from the first timing.

According to an embodiment of the present invention, the processor may compare a first time taken for the autonomous vehicle to arrive at the branch point with a second time taken to create the second level route based on the first level route received at the second timing and determine whether to maintain a current speed of the autonomous vehicle based on a result of the comparison.

According to an embodiment of the present invention, if the first time is shorter than the second time, the processor may decelerate the autonomous vehicle. If the first time is longer than the second time, the processor may maintain the current speed of the autonomous vehicle.

According to an embodiment of the present invention, the processor may set a margin area forming a prescribed margin outside the autonomous vehicle and output the margin area through an output unit.

According to an embodiment of the present invention, the margin area may include a first margin area forming a prescribed margin by including the second level route of the autonomous vehicle and a second margin area forming a prescribed margin by including the first margin area.

According to an embodiment of the present invention, the processor may determine complexity of the second level route and adjusts the margin area based on the complexity.

According to an embodiment of the present invention, the processor may determine the complexity of the second level route based on at least one of a forward or backward repetition count of the autonomous vehicle, steering wheel manipulation information, and a distance from a parking slot.

According to an embodiment of the present invention, the processor may determine at least one of a location, an approach direction and a speed of an obstacle approaching the margin area and controls an operation of the autonomous vehicle based on the determination.

According to an embodiment of the present invention, the processor may determine the at least one of the location, the approach direction and the speed of the obstacle by receiving information on a running characteristic or intention of the obstacle from the obstacle using vehicle-to-vehicle communication through the communication device.

According to an embodiment of the present invention, the processor may determine the at least one of the location, the approach direction and the speed of the obstacle from the obstacle by estimating a running characteristic or intention of the obstacle based on a previously learned action pattern of a moving obstacle.

Details of the embodiments are included in DETAILED DESCRIPTION OF THE INVENTION and the accompanying drawings.

Accordingly, embodiments of the present invention provide various effects and/or features.

First of all, according to an embodiment of the present invention, when an incident occurs in the course of driving, a processor of an autonomous vehicle creates a branch point for avoiding collision with an obstacle and recreates a route adaptively.

Secondly, according to an embodiment of the present invention, collision with an obstacle can be prevented beforehand by setting a margin area forming a prescribed margin around an autonomous vehicle and sending a warning message on the occasion that the obstacle enters the margin area.

Effects obtainable from the present invention may be non-limited by the above mentioned effect. And, other unmentioned effects can be clearly understood from the following description by those having ordinary skill in the technical field to which the present invention pertains.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a diagram showing an exterior of a vehicle according to an embodiment of the present invention;

FIG. 2 is a diagram showing a vehicle externally viewed in various angles according to an embodiment of the present invention;

FIG. 3 and FIG. 4 are diagrams showing an interior of a vehicle according to an embodiment of the present invention;

FIG. 5 and FIG. 6 are diagrams referred to for description of an object according to an embodiment of the present invention;

FIG. 7 is a block diagram referred to for description of a vehicle according to an embodiment of the present invention;

FIG. 8 is a flowchart of a method for controlling an autonomous vehicle according to a first embodiment of the present invention;

FIG. 9 is a diagram showing the relation between a server and an autonomous vehicle according to a first embodiment of the present invention;

FIG. 10 is a diagram to describe a sensing area and a communication coverage area of an autonomous vehicle according to a first embodiment of the present invention;

FIG. 11 is a diagram to describe a first level route and a second level route of an autonomous vehicle according to a first embodiment of the present invention;

FIG. 12 is a flowchart showing a method of controlling an autonomous vehicle according to a second embodiment of the present invention;

FIG. 13 is a flowchart showing a method of controlling an autonomous vehicle according to a second embodiment of the present invention;

FIG. 14 is a diagram showing a case that an autonomous vehicle according to a second embodiment of the present invention creates a branch point;

FIG. 15 is a diagram showing a case that an autonomous vehicle creates a branch point according to a second embodiment of the present invention;

FIG. 16 is a diagram showing a case that an autonomous vehicle does not create a branch point according to a second embodiment of the present invention;

FIG. 17 is a diagram showing a case that an autonomous vehicle does not create a branch point according to a second embodiment of the present invention;

FIG. 18 is a flowchart showing a method of controlling an autonomous vehicle according to a third embodiment of the present invention;

FIG. 19 is a diagram showing that an autonomous vehicle transceives information with an obstacle according to a third embodiment of the present invention;

FIG. 20 is a flowchart showing a method of controlling an autonomous vehicle according to a fourth embodiment of the present invention;

FIG. 21 is a diagram showing a margin area of an autonomous vehicle according to a fourth embodiment of the present invention;

FIG. 22 is a diagram showing that a margin area of an autonomous vehicle according to a fourth embodiment of the present invention is outputted through an output unit;

FIG. 23 is a diagram showing that a processor of an autonomous vehicle according to a fourth embodiment of the present invention adjusts a margin area;

FIG. 24 is a diagram showing that a processor an autonomous vehicle according to a fourth embodiment of the present invention further sets a third margin area;

FIG. 25 is a diagram showing that a processor of an autonomous vehicle according to a fourth embodiment of the present invention controls an operation of the autonomous vehicle based on a running characteristic or intention of another vehicle; and

FIG. 26 is a diagram showing that a processor of an autonomous vehicle 100 according to a fourth embodiment of the present invention creates a parking track using vehicle-to-vehicle communication.

### DETAILED DESCRIPTION OF THE INVENTION

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve as different meanings. Accordingly, the suffixes “module” and “unit” may be interchanged with each other. In addition, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present disclosure.

It will be understood that although the terms “first,” “second,” etc., may be used herein to describe various components, these components should not be limited by these terms. These terms are only used to distinguish one component from another component.

It will be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise.

In the present application, it will be further understood that the terms “comprises”, includes,” etc. specify the presence of stated features, integers, steps, operations, elements, components, or combinations thereof, but do not preclude the presence or addition of one or more other features, integers, steps, operations, elements, components, or combinations thereof.

A vehicle described in this specification may include, but is not limited to, an automobile and a motorcycle. Hereinafter, a description will be given based on an automobile.

A vehicle described in this specification may include, but is not limited to, various types of internal combustion engine vehicles including an engine as a power source, a hybrid vehicle including both an engine and an electric motor as a power source, and an electric vehicle including an electric motor as a power source.

In the following description, “the left side of the vehicle” refers to the left side in the forward driving direction of the vehicle, and “the right side of the vehicle” refers to the right side in the forward driving direction of the vehicle.

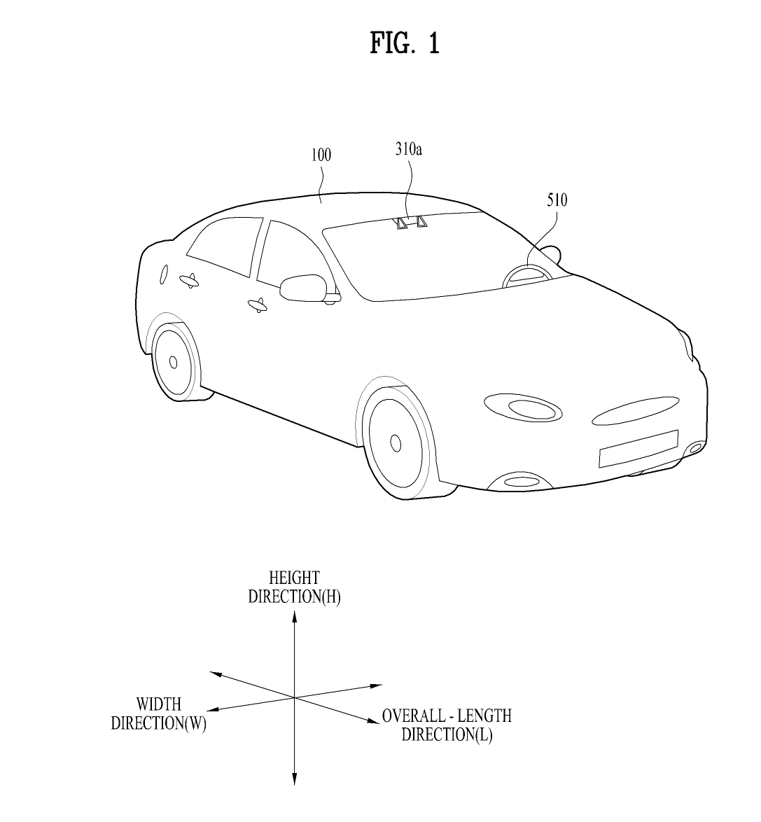

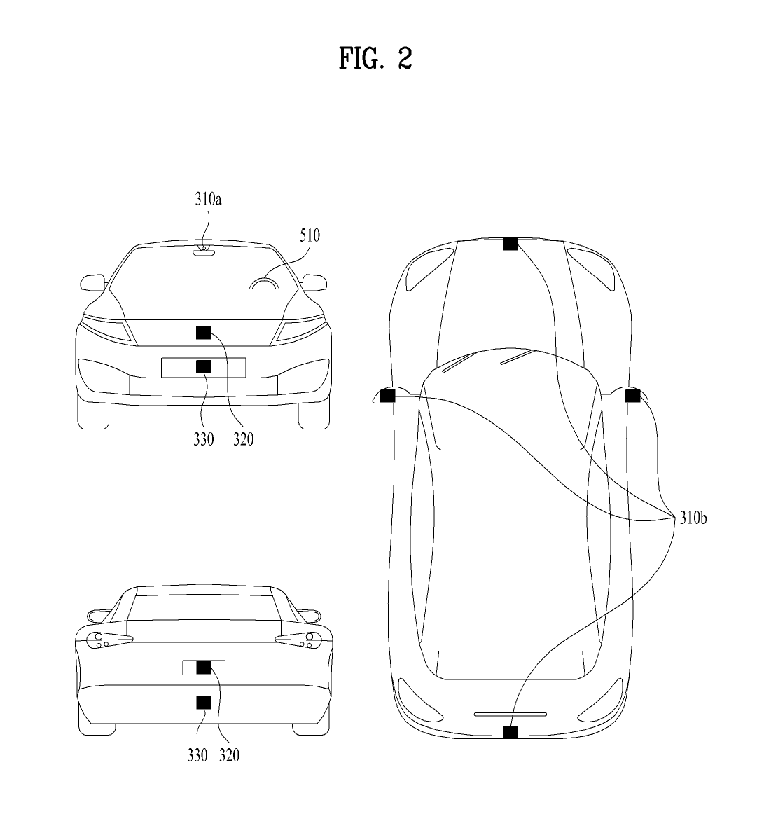

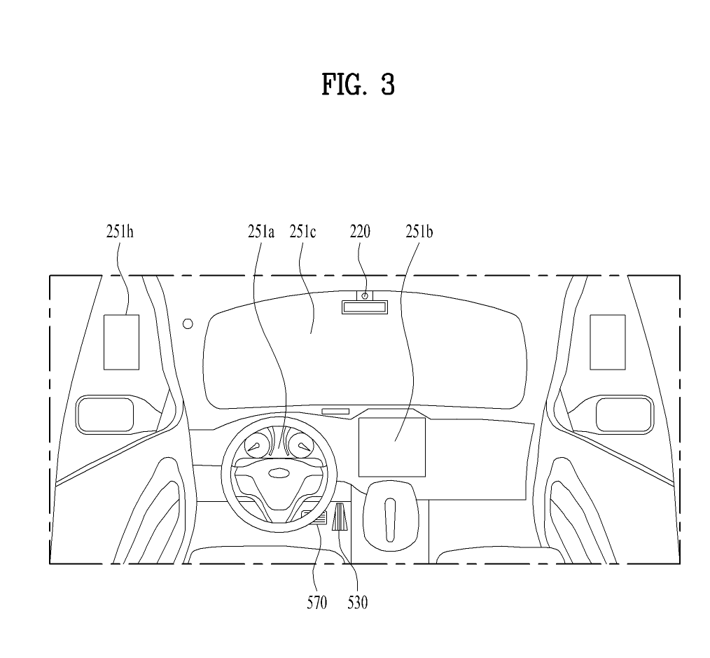

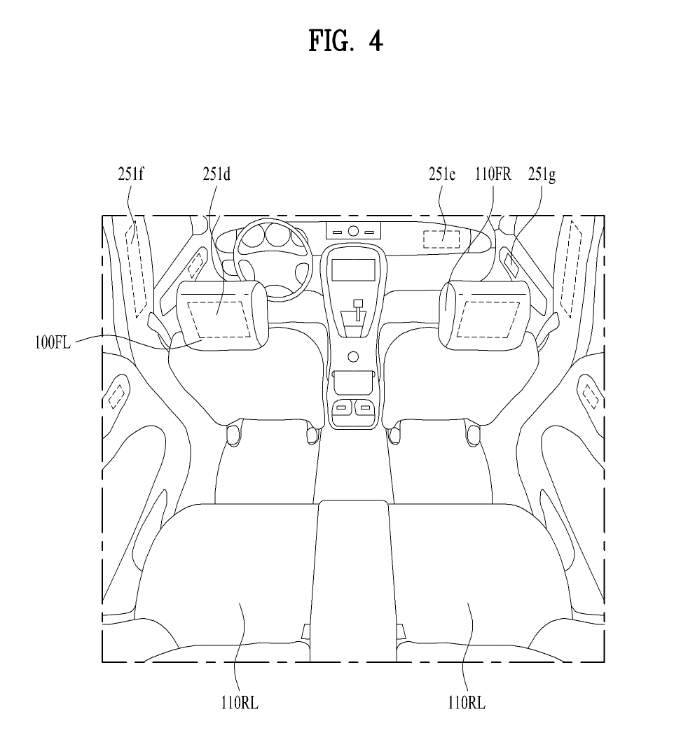

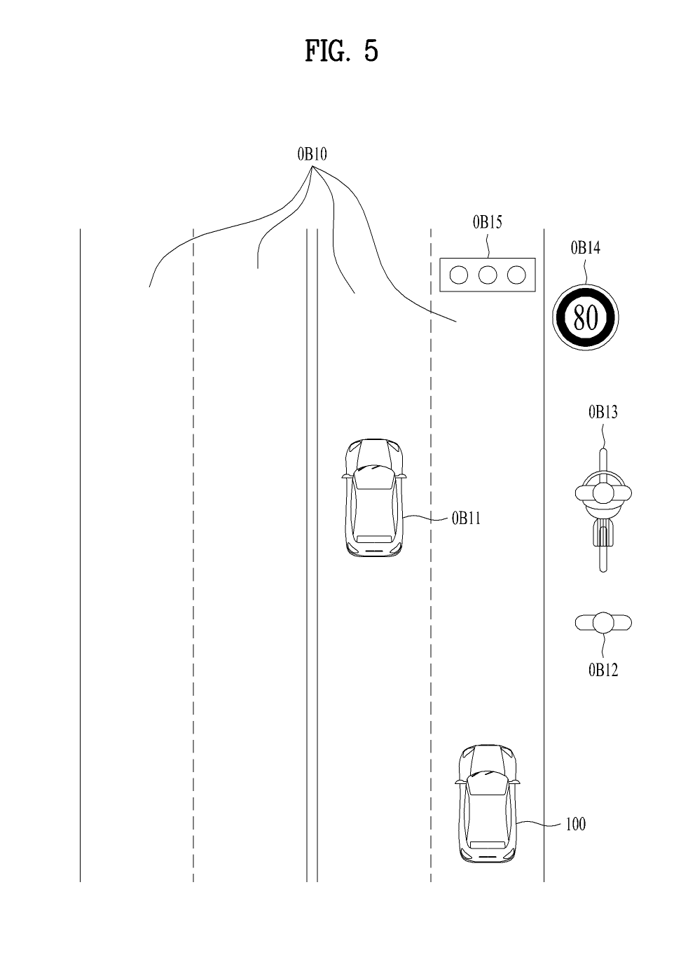

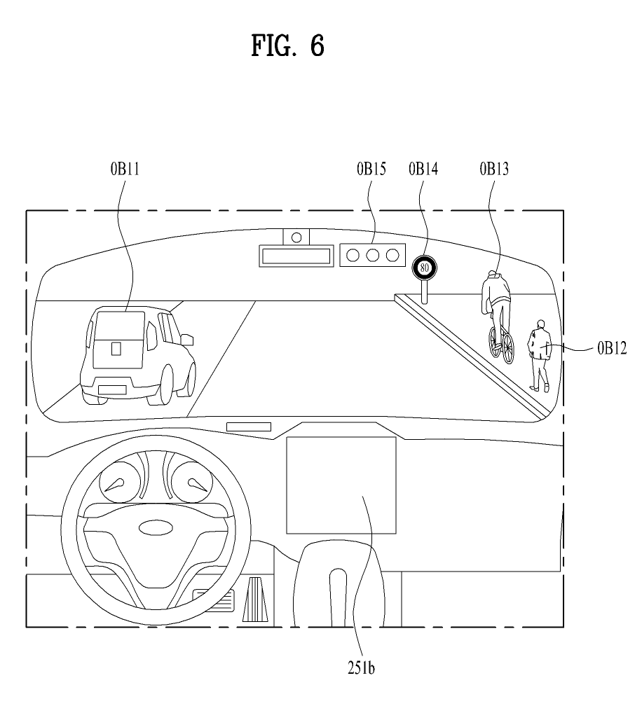

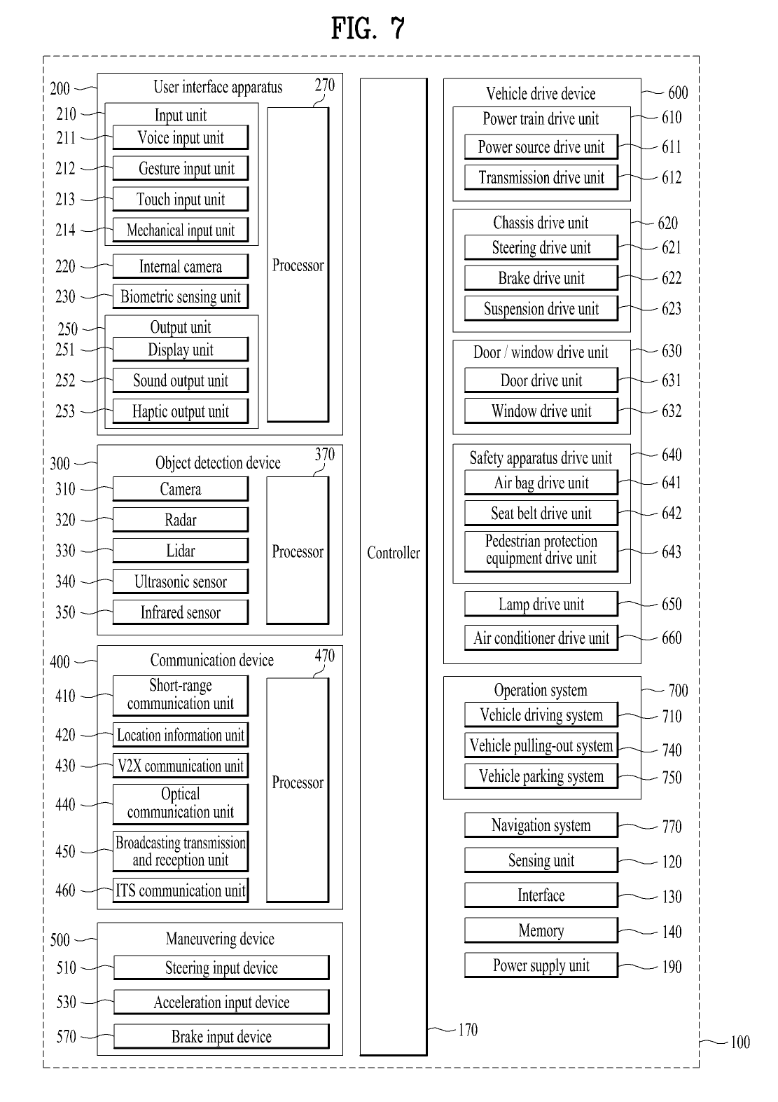

FIG. 1 is a view of the external appearance of a vehicle according to an implementation of the present disclosure, FIG. 2 is different angled views of a vehicle according to an implementation of the present disclosure, FIGS. 3 and 4 are views of the internal configuration of a vehicle according to an implementation of the present disclosure, FIGS. 5 and 6 are views for explanation of objects according to an implementation of the present disclosure, and FIG. 7 is a block diagram illustrating a vehicle according to an implementation of the present disclosure.

Referring to FIGS. 1 to 7, a vehicle 100 may include a plurality of wheels, which are rotated by a power source, and a steering input device 510 for controlling a driving direction of the vehicle 100.

The vehicle 100 may be an autonomous vehicle.

The vehicle 100 may be switched to an autonomous mode or a manual mode in response to a user input.

For example, in response to a user input received through a user interface device 200, the vehicle 100 may be switched from a manual mode to an autonomous mode, or vice versa.

The vehicle 100 may be switched to the autonomous mode or to the manual mode based on driving environment information.

The driving environment information may include at least one of the following: information on an object outside a vehicle, navigation information, and vehicle state information.

For example, the vehicle 100 may be switched from the manual mode to the autonomous mode, or vice versa, based on driving environment information generated by the object detection device 300.

In another example, the vehicle 100 may be switched from the manual mode to the autonomous mode, or vice versa, based on driving environment information received through a communication device 400.

The vehicle 100 may be switched from the manual mode to the autonomous mode, or vice versa, based on information, data, and a signal provided from an external device.

When the vehicle 100 operates in the autonomous mode, the autonomous vehicle 100 may operate based on an operation system 700.

For example, the autonomous vehicle 100 may operate based on information, data, or signals generated by a driving system 710, a vehicle pulling-out system 740, and a vehicle parking system 750.

While operating in the manual mode, the autonomous vehicle 100 may receive a user input for driving of the vehicle 100 through a maneuvering device 500. In response to the user input received through the maneuvering device 500, the vehicle 100 may operate.

The term “overall length” is the length from the front end to the rear end of the vehicle 100, the term “overall width” is the width of the vehicle 100, and the term “overall height” is the height from the bottom of the wheel to the roof. In the following description, the term “overall length direction L” may mean the reference direction for the measurement of the overall length of the vehicle 100, the term “overall width direction W” may mean the reference direction for the measurement of the overall width of the vehicle 100, and the term “overall height direction H” may mean the reference direction for the measurement of the overall height of the vehicle 100.

As illustrated in FIG. 7, the vehicle 100 may include the user interface device 200, the object detection device 300, the communication device 400, the maneuvering device 500, a vehicle drive device 600, the operation system 700, a navigation system 770, a sensing unit 120, an interface 130, a memory 140, a controller 170, and a power supply unit 190.

In some implementations, the vehicle 100 may further include other components in addition to the aforementioned components, or may not include some of the aforementioned components.

The sensing unit 120 may sense the state of the vehicle. The sensing unit 120 may include an attitude sensor (for example, a yaw sensor, a roll sensor, or a pitch sensor), a collision sensor, a wheel sensor, a speed sensor, a gradient sensor, a weight sensor, a heading sensor, a gyro sensor, a position module, a vehicle forward/reverse movement sensor, a battery sensor, a fuel sensor, a tire sensor, a steering sensor based on the rotation of the steering wheel, an in-vehicle temperature sensor, an in-vehicle humidity sensor, an ultrasonic sensor, an illumination sensor, an accelerator pedal position sensor, and a brake pedal position sensor.

The sensing unit 120 may acquire sensing signals with regard to, for example, vehicle attitude information, vehicle collision information, vehicle driving direction information, vehicle location information (GPS information), vehicle angle information, vehicle speed information, vehicle acceleration information, vehicle tilt information, vehicle forward/reverse movement information, battery information, fuel information, tire information, vehicle lamp information, in-vehicle temperature information, in-vehicle humidity information, steering-wheel rotation angle information, outside illumination information, information about the pressure applied to an accelerator pedal, and information about the pressure applied to a brake pedal.

The sensing unit 120 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The sensing unit 120 may generate vehicle state information based on sensing data. The vehicle condition information may be information that is generated based on data sensed by a variety of sensors inside a vehicle.

For example, the vehicle state information may include vehicle position information, vehicle speed information, vehicle tilt information, vehicle weight information, vehicle direction information, vehicle battery information, vehicle fuel information, vehicle tire pressure information, vehicle steering information, in-vehicle temperature information, in-vehicle humidity information, pedal position information, vehicle engine temperature information, etc.

The interface 130 may serve as a passage for various kinds of external devices that are connected to the vehicle 100. For example, the interface 130 may have a port that is connectable to a mobile terminal and may be connected to the mobile terminal via the port. In this case, the interface 130 may exchange data with the mobile terminal.

In some implementations, the interface 130 may serve as a passage for the supply of electrical energy to a mobile terminal connected thereto. When the mobile terminal is electrically connected to the interface 130, the interface 130 may provide electrical energy, supplied from the power supply unit 190, to the mobile terminal under control of the controller 170.

The memory 140 is electrically connected to the controller 170. The memory 140 may store basic data for each unit, control data for the operational control of each unit, and input/output data. The memory 140 may be any of various hardware storage devices, such as a ROM, a RAM, an EPROM, a flash drive, and a hard drive. The memory 140 may store various data for the overall operation of the vehicle 100, such as programs for the processing or control of the controller 170.

In some implementations, the memory 140 may be integrally formed with the controller 170, or may be provided as an element of the controller 170.

The controller 170 may control the overall operation of each unit inside the vehicle 100. The controller 170 may be referred to as an Electronic Controller (ECU).

The power supply unit 190 may supply power required to operate each component under control of the controller 170. In particular, the power supply unit 190 may receive power from, for example, a battery inside the vehicle 100.

At least one processor and the controller 170 included in the vehicle 100 may be implemented using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

Further, each of the sensing unit 120, the interface unit 130, the memory 140, the power supply unit 190, the user interface device 200, the object detection device 300, the communication device 400, the maneuvering device 500, the vehicle drive device 600, the operation system 700, and the navigation system 770 may have an individual processor or may be incorporated in the controller 170.

The user interface device 200 is provided to support communication between the vehicle 100 and a user. The user interface device 200 may receive a user input, and provide information generated in the vehicle 100 to the user. The vehicle 100 may enable User Interfaces (UI) or User Experience (UX) through the user interface device 200.

The user interface device 200 may include an input unit 210, an internal camera 220, a biometric sensing unit 230, an output unit 250, and a processor 270. Each component of the user interface device 200 may be separated from or integrated with the afore-described interface 130, structurally or operatively.

In some implementations, the user interface device 200 may further include other components in addition to the aforementioned components, or may not include some of the aforementioned components.

The input unit 210 is configured to receive information from a user, and data collected in the input unit 210 may be analyzed by the processor 270 and then processed into a control command of the user.

The input unit 210 may be disposed inside the vehicle 100. For example, the input unit 210 may be disposed in a region of a steering wheel, a region of an instrument panel, a region of a seat, a region of each pillar, a region of a door, a region of a center console, a region of a head lining, a region of a sun visor, a region of a windshield, or a region of a window.

The input unit 210 may include a voice input unit 211, a gesture input unit 212, a touch input unit 213, and a mechanical input unit 214.

The voice input unit 211 may convert a voice input of a user into an electrical signal. The converted electrical signal may be provided to the processor 270 or the controller 170.

The voice input unit 211 may include one or more microphones.

The gesture input unit 212 may convert a gesture input of a user into an electrical signal. The converted electrical signal may be provided to the processor 270 or the controller 170.

The gesture input unit 212 may include at least one selected from among an infrared sensor and an image sensor for sensing a gesture input of a user.

In some implementations, the gesture input unit 212 may sense a three-dimensional (3D) gesture input of a user. To this end, the gesture input unit 212 may include a plurality of light emitting units for outputting infrared light, or a plurality of image sensors.

The gesture input unit 212 may sense the 3D gesture input by employing a time of flight (TOF) scheme, a structured light scheme, or a disparity scheme.

The touch input unit 213 may convert a user's touch input into an electrical signal. The converted electrical signal may be provided to the processor 270 or the controller 170.

The touch input unit 213 may include a touch sensor for sensing a touch input of a user.

In some implementations, the touch input unit 210 may be formed integral with a display unit 251 to implement a touch screen. The touch screen may provide an input interface and an output interface between the vehicle 100 and the user.

The mechanical input unit 214 may include at least one selected from among a button, a dome switch, a jog wheel, and a jog switch. An electrical signal generated by the mechanical input unit 214 may be provided to the processor 270 or the controller 170.

The mechanical input unit 214 may be located on a steering wheel, a center fascia, a center console, a cockpit module, a door, etc.

The processor 270 may start a learning mode of the vehicle 100 in response to a user input to at least one of the afore-described voice input unit 211, gesture input unit 212, touch input unit 213, or mechanical input unit 214. In the learning mode, the vehicle 100 may learn a driving route and ambient environment of the vehicle 100. The learning mode will be described later in detail in relation to the object detection device 300 and the operation system 700.

The internal camera 220 may acquire images of the inside of the vehicle 100. The processor 270 may sense a user's condition based on the images of the inside of the vehicle 100.

The processor 270 may acquire information on an eye gaze of the user. The processor 270 may sense a gesture of the user from the images of the inside of the vehicle 100.

The biometric sensing unit 230 may acquire biometric information of the user. The biometric sensing unit 230 may include a sensor for acquire biometric information of the user, and may utilize the sensor to acquire finger print information, heart rate information, etc. of the user. The biometric information may be used for user authentication.

The output unit 250 is configured to generate a visual, audio, or tactile output.

The output unit 250 may include at least one selected from among a display unit 251, a sound output unit 252, and a haptic output unit 253.

The display unit 251 may display graphic objects corresponding to various types of information.

The display unit 251 may include at least one selected from among a Liquid Crystal Display (LCD), a Thin Film Transistor-Liquid Crystal Display (TFT LCD), an Organic Light-Emitting Diode (OLED), a flexible display, a 3D display, and an e-ink display.

The display unit 251 may form an inter-layer structure together with the touch input unit 213, or may be integrally formed with the touch input unit 213 to implement a touch screen.

The display unit 251 may be implemented as a head up display (HUD). When implemented as a HUD, the display unit 251 may include a projector module in order to output information through an image projected on a windshield or a window.

The display unit 251 may include a transparent display. The transparent display may be attached on the windshield or the window.

The transparent display may display a predetermined screen with a predetermined transparency. In order to achieve the transparency, the transparent display may include at least one selected from among a transparent Thin Film Electroluminescent (TFEL) display, an Organic Light Emitting Diode (OLED) display, a transparent Liquid Crystal Display (LCD), a transmissive transparent display, and a transparent Light Emitting Diode (LED) display. The transparency of the transparent display may be adjustable.

In some implementations, the user interface device 200 may include a plurality of display units 251a to 251g.

The display unit 251 may be disposed in a region of a steering wheel, a region 251a, 251b or 251e of an instrument panel, a region 251d of a seat, a region 251f of each pillar, a region 251g of a door, a region of a center console, a region of a head lining, a region of a sun visor, a region 251c of a windshield, or a region 251h of a window.

The sound output unit 252 converts an electrical signal from the processor 270 or the controller 170 into an audio signal, and outputs the audio signal. To this end, the sound output unit 252 may include one or more speakers.

The haptic output unit 253 generates a tactile output. For example, the haptic output unit 253 may operate to vibrate a steering wheel, a safety belt, and seats 110FL, 110FR, 110RL, and 110RR so as to allow a user to recognize the output.

The processor 270 may control the overall operation of each unit of the user interface device 200.

In some implementations, the user interface device 200 may include a plurality of processors 270 or may not include the processor 270.

In a case where the user interface device 200 does not include the processor 270, the user interface device 200 may operate under control of the controller 170 or a processor of a different device inside the vehicle 100.

In some implementations, the user interface device 200 may be referred to as a display device for a vehicle.

The user interface device 200 may operate under control of the controller 170.

The object detection device 300 is used to detect an object outside the vehicle 100. The object detection device 300 may generate object information based on sensing data.

The object information may include information about the presence of an object, location information of the object, information on distance between the vehicle and the object, and the speed of the object relative to the vehicle 100.

The object may include various objects related to travelling of the vehicle 100.

Referring to FIGS. 5 and 6, an object o may include a lane OB10, a nearby vehicle OB11, a pedestrian OB12, a two-wheeled vehicle OB13, a traffic signal OB14 and OB15, a light, a road, a structure, a bump, a geographical feature, an animal, etc.

The lane OB10 may be a lane in which the vehicle 100 is traveling (hereinafter, referred to as the current driving lane), a lane next to the current driving lane, and a lane in which a vehicle travelling in the opposite direction is travelling. The lane OB10 may include left and right lines that define the lane.

The nearby vehicle OB11 may be a vehicle that is travelling in the vicinity of the vehicle 100. The nearby vehicle OB11 may be a vehicle within a predetermined distance from the vehicle 100. For example, the nearby vehicle OB11 may be a vehicle that is preceding or following the vehicle 100.

The pedestrian OB12 may be a person in the vicinity of the vehicle 100. The pedestrian OB12 may be a person within a predetermined distance from the vehicle 100. For example, the pedestrian OB12 may be a person on a sidewalk or on the roadway.

The two-wheeled vehicle OB13 is a vehicle that is located in the vicinity of the vehicle 100 and moves with two wheels. The two-wheeled vehicle OB13 may be a vehicle that has two wheels within a predetermined distance from the vehicle 100. For example, the two-wheeled vehicle OB13 may be a motorcycle or a bike on a sidewalk or the roadway.

The traffic signal may include a traffic light OB15, a traffic sign plate OB14, and a pattern or text painted on a road surface.

The light may be light generated by a lamp provided in the nearby vehicle. The light may be light generated by a street light. The light may be solar light.

The road may include a road surface, a curve, and slopes, such as an upward slope and a downward slope.

The structure may be a body located around the road in the state of being fixed onto the ground. For example, the structure may include a streetlight, a roadside tree, a building, a traffic light, and a bridge.

The geographical feature may include a mountain and a hill.

In some implementations, the object may be classified as a movable object or a stationary object. For example, the movable object may include a nearby vehicle and a pedestrian. For example, the stationary object may include a traffic signal, a road, and a structure.

The object detection device 300 may include a camera 310, a radar 320, a LIDAR 330, an ultrasonic sensor 340, an infrared sensor 350, and a processor 370. Each component of the object detection device may be separated from or integrated with the sensing unit, structurally or operatively.

In some implementations, the object detection device 300 may further include other components in addition to the aforementioned components, or may not include some of the aforementioned components.

The camera 310 may be located at an appropriate position outside the vehicle 100 in order to acquire images of the outside of the vehicle 100. The camera 310 may be a mono camera, a stereo camera 310a, an around view monitoring (AVM) camera 310b, or a 360-degree camera.

Using various image processing algorithms, the camera 310 may acquire location information of an object, information on distance to the object, and information on speed relative to the object.

For example, based on change in size over time of an object in acquired images, the camera 310 may acquire information on distance to the object and information on speed relative to the object.

For example, the camera 310 may acquire the information on distance to the object and the information on speed relative to the object by utilizing a pin hole model or by profiling a road surface.

For example, the camera 310 may acquire the information on distance to the object and the information on the speed relative to the object, based on information on disparity of stereo images acquired by a stereo camera 310a.

For example, the camera 310 may be disposed near a front windshield in the vehicle 100 in order to acquire images of the front of the vehicle 100. Alternatively, the camera 310 may be disposed around a front bumper or a radiator grill.

In another example, the camera 310 may be disposed near a rear glass in the vehicle 100 in order to acquire images of the rear of the vehicle 100. Alternatively, the camera 310 may be disposed around a rear bumper, a trunk, or a tailgate.

In yet another example, the camera 310 may be disposed near at least one of the side windows in the vehicle 100 in order to acquire images of the side of the vehicle 100. Alternatively, the camera 310 may be disposed around a side mirror, a fender, or a door.

The camera 310 may provide an acquired image to the processor 370.

The radar 320 may include an electromagnetic wave transmission unit and an electromagnetic wave reception unit. The radar 320 may be realized as a pulse radar or a continuous wave radar depending on the principle of emission of an electronic wave. In addition, the radar 320 may be realized as a Frequency Modulated Continuous Wave (FMCW) type radar or a Frequency Shift Keying (FSK) type radar depending on the waveform of a signal.

The radar 320 may detect an object through the medium of an electromagnetic wave by employing a time of flight (TOF) scheme or a phase-shift scheme, and may detect a location of the detected object, the distance to the detected object, and the speed relative to the detected object.

The radar 320 may be located at an appropriate position outside the vehicle 100 in order to sense an object located in front of the vehicle 100, an object located to the rear of the vehicle 100, or an object located to the side of the vehicle 100.

The LIDAR 330 may include a laser transmission unit and a laser reception unit. The LIDAR 330 may be implemented by the TOF scheme or the phase-shift scheme.

The LIDAR 330 may be implemented as a drive type LIDAR or a non-drive type LIDAR.

When implemented as the drive type LIDAR, the LIDAR 330 may rotate by a motor and detect an object in the vicinity of the vehicle 100.

When implemented as the non-drive type LIDAR, the LIDAR 330 may utilize a light steering technique to detect an object located within a predetermined distance from the vehicle 100.

The LIDAR 330 may detect an object through the medium of laser light by employing the TOF scheme or the phase-shift scheme, and may detect a location of the detected object, the distance to the detected object, and the speed relative to the detected object.

The LIDAR 330 may be located at an appropriate position outside the vehicle 100 in order to sense an object located in front of the vehicle 100, an object located to the rear of the vehicle 100, or an object located to the side of the vehicle 100.

The ultrasonic sensor 340 may include an ultrasonic wave transmission unit and an ultrasonic wave reception unit. The ultrasonic sensor 340 may detect an object based on an ultrasonic wave, and may detect a location of the detected object, the distance to the detected object, and the speed relative to the detected object.

The ultrasonic sensor 340 may be located at an appropriate position outside the vehicle 100 in order to detect an object located in front of the vehicle 100, an object located to the rear of the vehicle 100, and an object located to the side of the vehicle 100.

The infrared sensor 350 may include an infrared light transmission unit and an infrared light reception unit. The infrared sensor 350 may detect an object based on infrared light, and may detect a location of the detected object, the distance to the detected object, and the speed relative to the detected object.

The infrared sensor 350 may be located at an appropriate position outside the vehicle 100 in order to sense an object located in front of the vehicle 100, an object located to the rear of the vehicle 100, or an object located to the side of the vehicle 100.

The processor 370 may control the overall operation of each unit of the object detection device 300.

The processor 370 may detect or classify an object by comparing data sensed by the camera 310, the radar 320, the LIDAR 330, the ultrasonic sensor 340, and the infrared sensor 350 with pre-stored data.

The processor 370 may detect and track an object based on acquired images. The processor 370 may, for example, calculate the distance to the object and the speed relative to the object.

For example, the processor 370 may acquire information on the distance to the object and information on the speed relative to the object based on a variation in size over time of the object in acquired images.

In another example, the processor 370 may acquire information on the distance to the object or information on the speed relative to the object by employing a pin hole model or by profiling a road surface.

In yet another example, the processor 370 may acquire information on the distance to the object and information on the speed relative to the object based on information on disparity of stereo images acquired from the stereo camera 310a.

The processor 370 may detect and track an object based on a reflection electromagnetic wave which is formed as a result of reflection a transmission electromagnetic wave by the object. Based on the electromagnetic wave, the processor 370 may, for example, calculate the distance to the object and the speed relative to the object.

The processor 370 may detect and track an object based on a reflection laser light which is formed as a result of reflection of transmission laser by the object. Based on the laser light, the processor 370 may, for example, calculate the distance to the object and the speed relative to the object.

The processor 370 may detect and track an object based on a reflection ultrasonic wave which is formed as a result of reflection of a transmission ultrasonic wave by the object. Based on the ultrasonic wave, the processor 370 may, for example, calculate the distance to the object and the speed relative to the object.

The processor 370 may detect and track an object based on reflection infrared light which is formed as a result of reflection of transmission infrared light by the object. Based on the infrared light, the processor 370 may, for example, calculate the distance to the object and the speed relative to the object.

As described before, once the vehicle 100 starts the learning mode in response to a user input to the input unit 210, the processor 370 may store data sensed by the camera 310, the radar 320, the LIDAR 330, the ultrasonic sensor 340, and the infrared sensor 350 in the memory 140.

Each step of the learning mode based on analysis of stored data, and an operating mode following the learning mode will be described later in detail in relation to the operation system 700. According to an implementation, the object detection device 300 may include a plurality of processors 370 or no processor 370. For example, the camera 310, the radar 320, the LIDAR 330, the ultrasonic sensor 340, and the infrared sensor 350 may include individual processors.

In a case where the object detection device 300 does not include the processor 370, the object detection device 300 may operate under control of the controller 170 or a processor inside the vehicle 100.

The object detection device 300 may operate under control of the controller 170.

The communication device 400 is configured to perform communication with an external device. Here, the external device may be a nearby vehicle, a mobile terminal, or a server.

To perform communication, the communication device 400 may include at least one selected from among a transmission antenna, a reception antenna, a Radio Frequency (RF) circuit capable of implementing various communication protocols, and an RF device.

The communication device 400 may include a short-range communication unit 410, a location information unit 420, a V2X communication unit 430, an optical communication unit 440, a broadcast transmission and reception unit 450, an Intelligent Transport Systems (ITS) communication unit 460, and a processor 470.

In some implementations, the communication device 400 may further include other components in addition to the aforementioned components, or may not include some of the aforementioned components.

The short-range communication unit 410 is configured to perform short-range communication. The short-range communication unit 410 may support short-range communication using at least one selected from among Bluetooth™, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, and Wireless USB (Wireless Universal Serial Bus).

The short-range communication unit 410 may form wireless area networks to perform short-range communication between the vehicle 100 and at least one external device.

The location information unit 420 is configured to acquire location information of the vehicle 100. For example, the location information unit 420 may include a Global Positioning System (GPS) module or a Differential Global Positioning System (DGPS) module.

The V2X communication unit 430 is configured to perform wireless communication between a vehicle and a server (that is, vehicle to infra (V2I) communication), wireless communication between a vehicle and a nearby vehicle (that is, vehicle to vehicle (V2V) communication), or wireless communication between a vehicle and a pedestrian (that is, vehicle to pedestrian (V2P) communication).

The optical communication unit 440 is configured to perform communication with an external device through the medium of light. The optical communication unit 440 may include a light emitting unit, which converts an electrical signal into an optical signal and transmits the optical signal to the outside, and a light receiving unit which converts a received optical signal into an electrical signal.

In some implementations, the light emitting unit may be integrally formed with a lamp provided included in the vehicle 100.

The broadcast transmission and reception unit 450 is configured to receive a broadcast signal from an external broadcasting management server or transmit a broadcast signal to the broadcasting management server through a broadcasting channel. The broadcasting channel may include a satellite channel, and a terrestrial channel. The broadcast signal may include a TV broadcast signal, a radio broadcast signal, and a data broadcast signal.

The ITS communication unit 460 may exchange information, data, or signals with a traffic system. The ITS communication unit 460 may provide acquired information or data to the traffic system. The ITS communication unit 460 may receive information, data, or signals from the traffic system. For example, the ITS communication unit 460 may receive traffic information from the traffic system and provide the traffic information to the controller 170. In another example, the ITS communication unit 460 may receive a control signal from the traffic system, and provide the control signal to the controller 170 or a processor provided in the vehicle 100.

The processor 470 may control the overall operation of each unit of the communication device 400.

In some implementations, the communication device 400 may include a plurality of processors 470, or may not include the processor 470.

In a case where the communication device 400 does not include the processor 470, the communication device 400 may operate under control of the controller 170 or a processor of a device inside of the vehicle 100.

In some implementations, the communication device 400 may implement a vehicle display device, together with the user interface device 200. In this case, the vehicle display device may be referred to as a telematics device or an audio video navigation (AVN) device.

The communication device 400 may operate under control of the controller 170.

The maneuvering device 500 is configured to receive a user input for driving the vehicle 100.

In the manual mode, the vehicle 100 may operate based on a signal provided by the maneuvering device 500.

The maneuvering device 500 may include a steering input device 510, an acceleration input device 530, and a brake input device 570.

The steering input device 510 may receive a user input with regard to the direction of travel of the vehicle 100. The steering input device 510 may take the form of a wheel to enable a steering input through the rotation thereof. In some implementations, the steering input device may be provided as a touchscreen, a touch pad, or a button.

The acceleration input device 530 may receive a user input for acceleration of the vehicle 100. The brake input device 570 may receive a user input for deceleration of the vehicle 100. Each of the acceleration input device 530 and the brake input device 570 may take the form of a pedal. In some implementations, the acceleration input device or the break input device may be configured as a touch screen, a touch pad, or a button.

The maneuvering device 500 may operate under control of the controller 170.

The vehicle drive device 600 is configured to electrically control the operation of various devices of the vehicle 100.

The vehicle drive device 600 may include a power train drive unit 610, a chassis drive unit 620, a door/window drive unit 630, a safety apparatus drive unit 640, a lamp drive unit 650, and an air conditioner drive unit 660.

In some implementations, the vehicle drive device 600 may further include other components in addition to the aforementioned components, or may not include some of the aforementioned components.

In some implementations, the vehicle drive device 600 may include a processor. Each unit of the vehicle drive device 600 may include its own processor.

The power train drive unit 610 may control the operation of a power train.

The power train drive unit 610 may include a power source drive unit 611 and a transmission drive unit 612.

The power source drive unit 611 may control a power source of the vehicle 100.

In the case in which a fossil fuel-based engine is the power source, the power source drive unit 611 may perform electronic control of the engine. As such the power source drive unit 611 may control, for example, the output torque of the engine. The power source drive unit 611 may adjust the output toque of the engine under control of the controller 170.

In a case where an electric motor is the power source, the power source drive unit 611 may control the motor. The power train drive unit 610 may control, for example, the RPM and toque of the motor under control of the controller 170.

The transmission drive unit 612 may control a transmission.

The transmission drive unit 612 may adjust the state of the transmission. The transmission drive unit 612 may adjust a state of the transmission to a drive (D), reverse (R), neutral (N), or park (P) state.

In some implementations, for example, in a case where an engine is the power source, the transmission drive unit 612 may adjust a gear-engaged state to the drive position D.

The chassis drive unit 620 may control the operation of a chassis.

The chassis drive unit 620 may include a steering drive unit 621, a brake drive unit 622, and a suspension drive unit 623.

The steering drive unit 621 may perform electronic control of a steering apparatus provided inside the vehicle 100. The steering drive unit 621 may change the direction of travel of the vehicle 100.

The brake drive unit 622 may perform electronic control of a brake apparatus provided inside the vehicle 100. For example, the brake drive unit 622 may reduce the speed of the vehicle 100 by controlling the operation of a brake located at a wheel.

In some implementations, the brake drive unit 622 may control a plurality of brakes individually. The brake drive unit 622 may apply a different degree-braking force to each wheel.

The suspension drive unit 623 may perform electronic control of a suspension apparatus inside the vehicle 100. For example, when the road surface is uneven, the suspension drive unit 623 may control the suspension apparatus so as to reduce the vibration of the vehicle 100.

In some implementations, the suspension drive unit 623 may control a plurality of suspensions individually.

The door/window drive unit 630 may perform electronic control of a door apparatus or a window apparatus inside the vehicle 100.

The door/window drive unit 630 may include a door drive unit 631 and a window drive unit 632.

The door drive unit 631 may control the door apparatus. The door drive unit 631 may control opening or closing of a plurality of doors included in the vehicle 100. The door drive unit 631 may control opening or closing of a trunk or a tail gate. The door drive unit 631 may control opening or closing of a sunroof.

The window drive unit 632 may perform electronic control of the window apparatus. The window drive unit 632 may control opening or closing of a plurality of windows included in the vehicle 100.

The safety apparatus drive unit 640 may perform electronic control of various safety apparatuses provided inside the vehicle 100.

The safety apparatus drive unit 640 may include an airbag drive unit 641, a safety belt drive unit 642, and a pedestrian protection equipment drive unit 643.

The airbag drive unit 641 may perform electronic control of an airbag apparatus inside the vehicle 100. For example, upon detection of a dangerous situation, the airbag drive unit 641 may control an airbag to be deployed.

The safety belt drive unit 642 may perform electronic control of a seatbelt apparatus inside the vehicle 100. For example, upon detection of a dangerous situation, the safety belt drive unit 642 may control passengers to be fixed onto seats 110FL, 110FR, 110RL, and 110RR with safety belts.

The pedestrian protection equipment drive unit 643 may perform electronic control of a hood lift and a pedestrian airbag. For example, upon detection of a collision with a pedestrian, the pedestrian protection equipment drive unit 643 may control a hood lift and a pedestrian airbag to be deployed.

The lamp drive unit 650 may perform electronic control of various lamp apparatuses provided inside the vehicle 100.

The air conditioner drive unit 660 may perform electronic control of an air conditioner inside the vehicle 100. For example, when the inner temperature of the vehicle 100 is high, an air conditioner drive unit 660 may operate the air conditioner so as to supply cool air to the inside of the vehicle 100.

The vehicle drive device 600 may include a processor. Each unit of the vehicle drive device 600 may include its own processor.

The vehicle drive device 600 may operate under control of the controller 170.

The operation system 700 is a system for controlling the overall driving operation of the vehicle 100. The operation system 700 may operate in the autonomous driving mode.

The operation system 700 may include the driving system 710, the vehicle pulling-out system 740, and the vehicle parking system 750.

In some implementations, the operation system 700 may further include other components in addition to the aforementioned components, or may not include some of the aforementioned component.

In some implementations, the operation system 700 may include a processor. Each unit of the operation system 700 may include its own processor.

In some implementations, the operation system 700 may control driving in the autonomous mode based on learning. In this case, the learning mode and an operating mode based on the premise of completion of learning may be performed. A description will be given below of a method of executing the learning mode and the operating mode by the processor of the operation system 700.

The learning mode may be performed in the afore-described manual mode. In the learning mode, the processor of the operation system 700 may learn a driving route and ambient environment of the vehicle 100.

The learning of the driving route may include generating map data for a route in which the vehicle 100 drives. Particularly, the processor of the operation system 700 may generate map data based on information detected through the object detection device 300 during driving from a departure to a destination.

The learning of the ambient environment may include storing and analyzing information about an ambient environment of the vehicle 100 during driving and parking. Particularly, the processor of the operation system 700 may store and analyze the information about the ambient environment of the vehicle based on information detected through the object detection device 300 during parking of the vehicle 100, for example, information about a location, size, and a fixed (or mobile) obstacle of a parking space.

The operating mode may be performed in the afore-described autonomous mode. The operating mode will be described based on the premise that the driving route or the ambient environment has been learned in the learning mode.

The operating mode may be performed in response to a user input through the input unit 210, or when the vehicle 100 reaches the learned driving route and parking space, the operating mode may be performed automatically.

The operating mode may include a semi-autonomous operating mode requiring some user's manipulations of the maneuvering device 500, and a full autonomous operating mode requiring no user's manipulation of the maneuvering device 500.

According to an implementation, the processor of the operation system 700 may drive the vehicle 100 along the learned driving route by controlling the driving system 710 in the operating mode.

According to an implementation, the processor of the operation system 700 may pull out the vehicle 100 from the learned parking space by controlling the vehicle pulling-out system 740 in the operating mode.

In some implementations, the processor of the operation system 700 may park the vehicle 100 in the learned parking space by controlling the vehicle parking system 750 in the operating mode. For example, in a case where the operation system 700 is implemented as software, the operation system 700 may be a subordinate concept of the controller 170.

In some implementations, the operation system 700 may be a concept including at least one selected from among the user interface device 200, the object detection device 300, the communication device 400, the vehicle drive device 600, and the controller 170.

The driving system 710 may perform driving of the vehicle 100.

The driving system 710 may perform driving of the vehicle 100 by providing a control signal to the vehicle drive device 600 in response to reception of navigation information from the navigation system 770.

The driving system 710 may perform driving of the vehicle 100 by providing a control signal to the vehicle drive device 600 in response to reception of object information from the object detection device 300.

The driving system 710 may perform driving of the vehicle 100 by providing a control signal to the vehicle drive device 600 in response to reception of a signal from an external device through the communication device 400.

Conceptually, the driving system 710 may be a system that drives the vehicle 100, including at least one of the user interface device 200, the object detection device 300, the communication device 400, the maneuvering device 500, the vehicle drive device 600, the navigation system 770, the sensing unit 120, or the controller 170.

The driving system 710 may be referred to as a vehicle driving control device.

The vehicle pulling-out system 740 may perform an operation of pulling the vehicle 100 out of a parking space.

The vehicle pulling-out system 740 may perform an operation of pulling the vehicle 100 out of a parking space, by providing a control signal to the vehicle drive device 600 in response to reception of navigation information from the navigation system 770.

The vehicle pulling-out system 740 may perform an operation of pulling the vehicle 100 out of a parking space, by providing a control signal to the vehicle drive device 600 in response to reception of object information from the object detection device 300.

The vehicle pulling-out system 740 may perform an operation of pulling the vehicle 100 out of a parking space, by providing a control signal to the vehicle drive device 600 in response to reception of a signal from an external device.

Conceptually, the vehicle pulling-out system 740 may be a system that performs pulling-out of the vehicle 100, including at least one of the user interface device 200, the object detection device 300, the communication device 400, the maneuvering device 500, the vehicle drive device 600, the navigation system 770, the sensing unit 120, or the controller 170.

The vehicle pulling-out system 740 may be referred to as a vehicle pulling-out control device.

The vehicle parking system 750 may perform an operation of parking the vehicle 100 in a parking space.

The vehicle parking system 750 may perform an operation of parking the vehicle 100 in a parking space, by providing a control signal to the vehicle drive device 600 in response to reception of navigation information from the navigation system 770.

The vehicle parking system 750 may perform an operation of parking the vehicle 100 in a parking space, by providing a control signal to the vehicle drive device 600 in response to reception of object information from the object detection device 300.

The vehicle parking system 750 may perform an operation of parking the vehicle 100 in a parking space, by providing a control signal to the vehicle drive device 600 in response to reception of a signal from an external device.

Conceptually, the vehicle parking system 750 may be a system that performs parking of the vehicle 100, including at least one of the user interface device 200, the object detection device 300, the communication device 400, the maneuvering device 500, the vehicle drive device 600, the navigation system 770, the sensing unit 120, or the controller 170.

The vehicle parking system 750 may be referred to as a vehicle parking control device.

The navigation system 770 may provide navigation information. The navigation information may include at least one selected from among map information, information on a set destination, information on a route to the set destination, information on various objects along the route, lane information, and information on a current location of the vehicle.

The navigation system 770 may include a memory and a processor. The memory may store navigation information. The processor may control the operation of the navigation system 770.

In some implementations, the navigation system 770 may update pre-stored information by receiving information from an external device through the communication device 400.

In some implementations, the navigation system 770 may be classified as an element of the user interface device 200.

### First Embodiment

According to a first embodiment of the present invention, an autonomous vehicle receives a route from a current location to a parking slot from a server and creates a route based on the received information and information sensed within a sensing area of the autonomous vehicle.

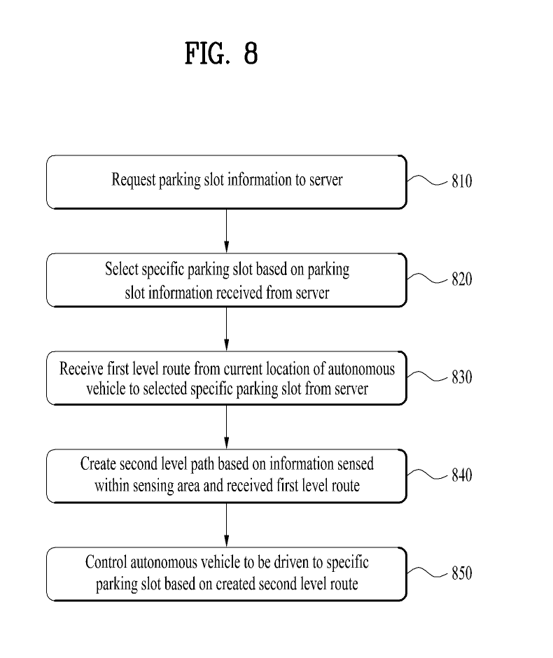

FIG. 8 is a flowchart of a method for controlling an autonomous vehicle according to a first embodiment of the present invention. Meanwhile, a processor of a vehicle 100 described in the following can be understood as the configuration responding to the controller 170 of FIG. 7.

Like a step 810 of FIG. 8, a processor of an autonomous vehicle 100 according to a first embodiment of the present invention may make a request for information on a vacant parking slot to a server (not shown) through a communication device 400. In response to the request, the processor of the vehicle 100 receives parking slot information on a location of a vacant parking slot, a required time to the parking slot and/or the like from the server through the communication device 400.

Like a step 820 of FIG. 8, a user can select a specific parking slot from the received parking slot information through a user interface device 200. Or, the processor of the autonomous vehicle 100 may select a specific parking slot by itself based on preset conditions (e.g., required time, distance, etc.). The processor of the autonomous vehicle 100 can make a request for a first level route to the selected specific parking slot to the server.

Like a step 830 of FIG. 8, at a first timing, the processor of the autonomous vehicle 100 receives the first level route from a current location to the selected specific parking slot from the server. The first level route is the route created by the server and may be referred to as a temporary route including the current location of the autonomous vehicle 100 and the location of the selected parking slot in order for the autonomous vehicle 100 to arrive at the selected parking slot from the current location of the autonomous vehicle 100.

Particularly, the first level route may further include data of a type (vertical parking or parallel parking) of the parking slot and data indicating whether the location of the parking slot is a ground parking lot or an underground parking lot and the like as well as the route data of the route from the current location of the autonomous vehicle 100 to the selected specific parking slot.

Like a step 840 of FIG. 8, the processor of the autonomous vehicle 100 creates a second level route based on information sensed within a sensing area of an object detecting device 300 and the received first level route.

Unlike the first level route that is the temporary route for the autonomous vehicle 100 to arrive at the selected parking slot from the current location, the second level route means an actual moving track of the autonomous vehicle 100 to actively cope with a rapidly changing ambient environment through sensing information. Hence, when an incident occurs, the processor of the autonomous vehicle 100 can create a branch point for avoiding collision with an obstacle and recreate the second level route adaptively.

Finally, like a step 850 of FIG. 8, the processor of the autonomous vehicle 100 controls the autonomous vehicle to be driven to the specific parking slot based on the created second level route.

According to the present invention, the autonomous vehicle comprises a driver assist apparatus. Hereinafter, the processor of the vehicle 100 described in the following can be understood as the configuration responding to the processor of the driver assist apparatus. An interface device may be an I/O port through which a signal is transceived between a plurality of component.

The driver assist apparatus comprises an interface device electrically connected to at least one object detecting device on an autonomous vehicle and a communication device, at least one processor and a non-transitory computer-readable medium coupled to the at least one processor having stored thereon instructions which, when executed by the at least one processor, causes the at least one processor to perform operations comprising, transmitting, through the communication device to a server, a request for parking slot information, receiving, through the communication device from the server, the parking slot information, selecting, by a user of the autonomous vehicle or by the at least one processor, a target parking slot based on the parking slot information, receiving, through the communication device from the server at a first time, a first level route from a current location of the autonomous vehicle to the target parking slot, generating a second level route based on (i) sensing information in a sensing area of the object detecting device and (ii) the first level route and controlling the autonomous vehicle to drive to the target parking slot based on the second level route.

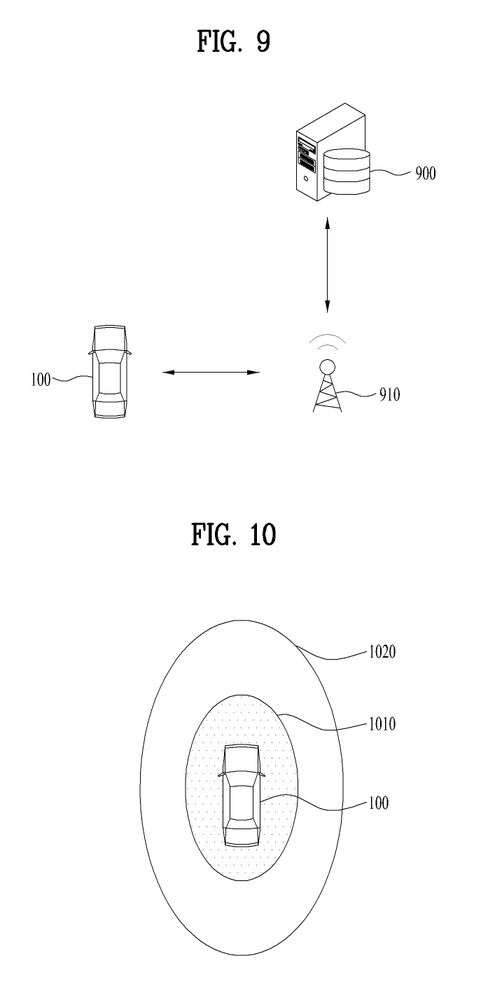

FIG. 9 is a diagram showing the relation between a server and an autonomous vehicle according to a first embodiment of the present invention.

According to an embodiment of the present invention, through the V2X communication unit 430 configuring the communication device 400 described in FIG. 7, an autonomous vehicle 100 can perform wireless communication with a server (V2I: vehicle to infra), another vehicle (V2V: vehicle to vehicle), or a pedestrian (V2P: vehicle to pedestrian). Particularly, as shown in FIG. 9, a processor of the vehicle 100 can communicate with a server 900 via an antenna or roadside base station 910 installed on a road by being spaced apart in a prescribed distance (e.g., 1˜1.5 km).

For the communication between the autonomous vehicle 100 and the server 900, DSRC/WAVE (dedicated short-range communication/wireless access in vehicular environments) is usable.

According to an embodiment of the present invention, the autonomous vehicle 100 makes a request for parking slot information to the server 900 by the aforementioned communication method and is able to receive parking slot information and a first level route to a selected parking slot from the server 900 in response to the request.

FIG. 10 is a diagram to describe a sensing area and a communication coverage area of an autonomous vehicle according to a first embodiment of the present invention.

Referring to FIG. 10, a sensing area 1010 having a prescribed radius (e.g., 10˜100 m) from an autonomous vehicle 100 can be determined according to an option of an object detecting device 300 such as a camera 310, a radar 320, a lidar 330, an ultrasonic sensor 340, an infrared (IR) sensor 350 and the like. Namely, the sensing area 1010 can be understood as an area from which the autonomous vehicle 100 can detect an ambient environment of the autonomous vehicle 100 through the object detecting device 300.

Meanwhile, a communication range having a prescribed radius from the autonomous vehicle 100, i.e., a communication coverage area 1020 can be determined depending on density of vehicles around the autonomous vehicle 100 and a radio propagation environment. Moreover, the communication coverage area 1020 can be determined based on an option of a communication device 400 of the autonomous vehicle 100 and may correspond to 150˜300 m.

The aforementioned numerical values of the sensing area 1010 and the communication coverage area 1020 are exemplary, by which a scope of the right of the present invention is non-limited.

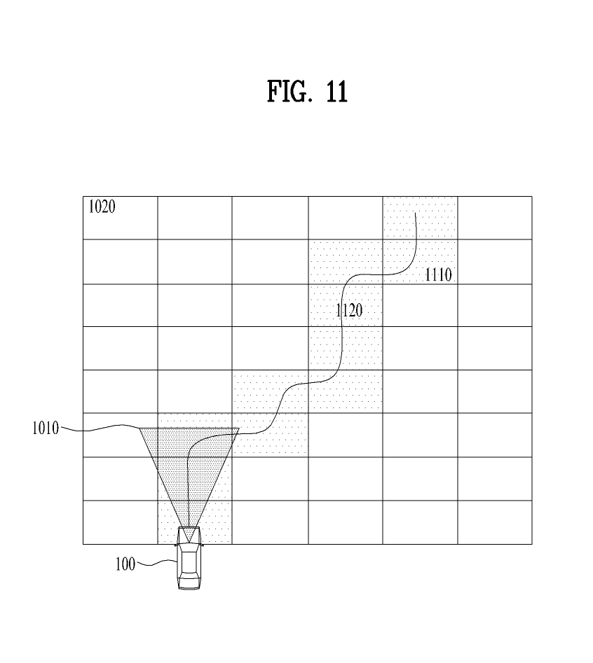

FIG. 11 is a diagram to describe a first level route and a second level route of an autonomous vehicle according to a first embodiment of the present invention. FIG. 11 is a diagram to describe the steps 830 to 850 of FIG. 8 in detail.

According to the step 830 of FIG. 8, the processor of the autonomous vehicle 100 receives a first level route 1110 to a selected specific parking slot from a server through the communication device 400. The first level route 1110 may be included in a communication coverage area 1020.

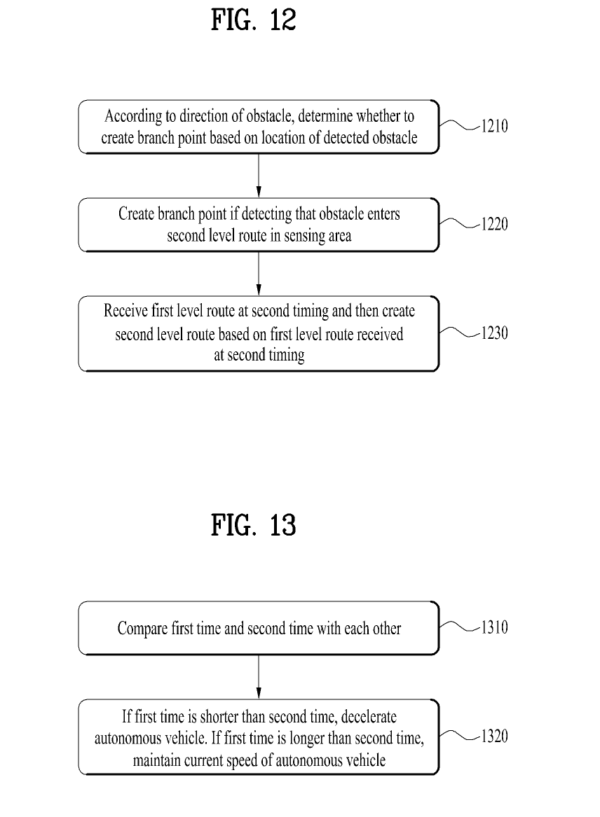

Particularly, the first level route 1110 means a rough route information containing a current location of the autonomous vehicle 100, a location of a specific parking slot (i.e., destination), and space information on a moving direction and moving route of the autonomous vehicle 100. The processor of the autonomous vehicle 100 may initially receive the first level route 1110 once only from the server 900, or receive an updated first level route 1110 plural times at a plurality of timings from the server 900. This shall be described in detail in a second embodiment shown in FIGS. 12 to 17.

The processor of the autonomous vehicle 100 creates a second level route 1120 based on the received first level route 1110 and information sensed within the sensing area 1010 of the object detecting device 300. Particularly, the processor of the autonomous vehicle 100 creates the second level route 1120 corresponding to an actual moving track of the autonomous vehicle 100 based on the first level route 1110 corresponding to the rough route information and the ambient environment information sensed within the sensing area 1010 of the object detecting device 300.

In particular, the second level route 1120 may be included in the first level route 1110. In response to a rapid change of the ambient environment of the autonomous vehicle 100, the processor of the autonomous vehicle 100 can create the second level route 1120 plural times at plural timings. This shall be described in detail in a second embodiment shown in FIGS. 12 to 17.

### Second Embodiment

A second embodiment of the present invention relates to a method for an autonomous vehicle 100 to cope with a case that an obstacle approaches a prescribed route while driving on the basis of a first level route and a second level route.

FIG. 12 is a flowchart showing a method of controlling an autonomous vehicle according to a second embodiment of the present invention. Steps 1210 to 1230 of FIG. 12 may be performed after the step 850 of FIG. 8.

Like a step 1210 of FIG. 12, as detecting an obstacle through the object detecting device 300, the processor of the autonomous vehicle 100 according to the second embodiment of the present invention determines whether to create a branch point based on a location of the detected obstacle. The obstacle means various objects (e.g., other vehicles, pedestrians, stop obstacles, moving obstacles, etc.) existing in an ambient environment of the autonomous vehicle 100.

Like a step 1220 of FIG. 12, if detecting that an obstacle enters a second level route in a sensing area, the processor of the autonomous vehicle 100 creates a branch point. The branch point is created on the second level route by the processor of the autonomous vehicle 100, and means a point at which the autonomous vehicle 100 changes its moving direction. From the branch point, the autonomous vehicle 100 drives on a new second level route different from the previously moving second level route.

Like a step 1230 of FIG. 12, the processor of the autonomous vehicle 100 receives a first level route at a second timing and creates a second level route at the second timing based on the received first level route. Namely, the processor of the autonomous vehicle 100 can receive the first level route plural times at plural timings.

The second timing is different from the first timing in the step 830 of FIG. 8 and may correspond to a timing after the first timing. Particularly, the second timing may include a timing at which an obstacle is detected as entering the second level route. For example, the processor of the autonomous vehicle 100 can create a new second level route immediately at the timing at which an obstacle is detected as entering the second level route. Yet, the processor of the autonomous vehicle 100 can receive a new first level route only if it is unable to create the new second level route immediately.

Or, the second timing may include a timing at which an obstacle is detected as entering the first level route in the sensing area. Since the obstacle having entered the first level route does not cause any direct effect to the driving of the autonomous vehicle 100, the processor of the autonomous vehicle 100 outputs information indicating that a branch point will be created through the output unit 250 and is able to create the branch point after detecting that the obstacle enters the second level route. FIG. 13 is a flowchart showing a method of controlling an autonomous vehicle according to a second embodiment of the present invention. Steps 1310 and 1320 of FIG. 13 may be performed after the step 1220 of FIG. 12. Namely, the following description is made on the assumption that the autonomous vehicle 100 creates the branch point by detecting that the obstacle enters the second level route within the sensing area.

Like a step 1310 of FIG. 13, the processor of the autonomous vehicle 100 compares a first time taken for the autonomous vehicle 100 to arrive at the branch point with a second time taken to create the second level route based on the first level route received at the second timing. And, the processor of the autonomous vehicle 100 determines whether to maintain a current speed of the autonomous vehicle 100 based on a result of the comparison.

Like a step 1320 of FIG. 13, if the first time is shorter than the second time, the processor of the autonomous vehicle 100 decelerates the autonomous vehicle 100 by controlling the brake input device 570. On the contrary, if the first time is longer than the second time, the processor of the autonomous vehicle 100 controls the autonomous vehicle 100 to maintain a current speed.

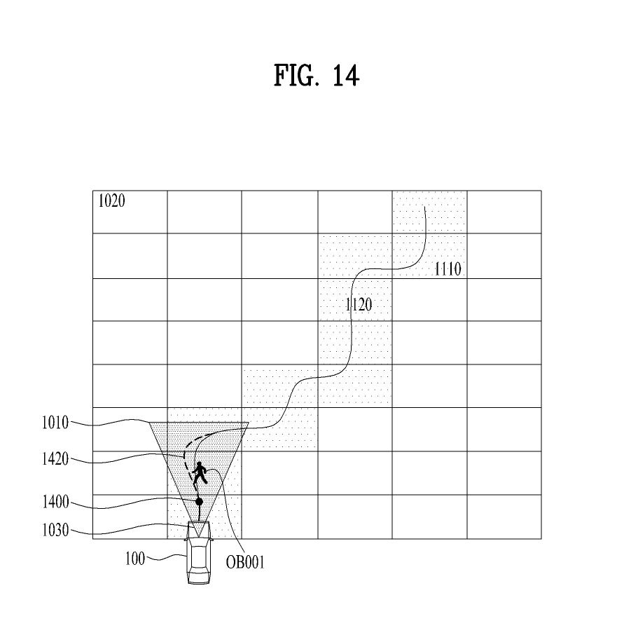

FIG. 14 is a diagram showing a case that an autonomous vehicle according to a second embodiment of the present invention creates a branch point. Particularly, FIG. 14 is a diagram to describe a processing method of a case that a branch point is located in an area 1030 seen by a user riding in the autonomous vehicle 100.

Referring to FIG. 14, if detecting that an obstacle OB001 enters a second level route 1120 in a sensing area 1010, the processor of the autonomous vehicle 100 creates a branch point 1400.

If the branch point 1400 exists in the area 1030 seen by the user riding the autonomous vehicle 100, it means that the obstacle OB001 is located very closely to the autonomous vehicle 100. Hence, if the branch point 1400 exists in the area 1030 seen by the user riding the autonomous vehicle 100, the processor of the autonomous vehicle 100 immediately stops the autonomous vehicle 100 by controlling the brake input device 570.

The processor of the autonomous vehicle 100 creates a route 1420 for avoiding the obstacle OB001 from the branch point 1400. Particularly, the processor of the autonomous vehicle 100 creates the route 1420 that is included in a first level route 1110 in a manner of setting a start location to the branch point 1400 and also setting an end location to a point at which the autonomous vehicle 100 can join the previously created second level route 1120 again.

According to the second embodiment of the present invention shown in FIG. 14, as an obstacle is detected from a location very close to an autonomous vehicle, if a first level route different from a previously received first level route is received from a server, the autonomous vehicle is stopped quickly in a situation of possible collision with the obstacle and a route for avoiding the obstacle can be created, advantageously.

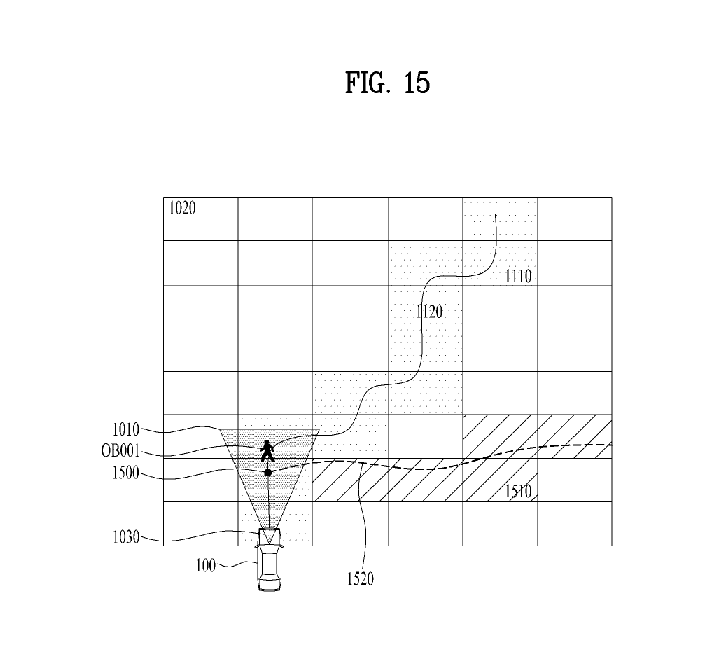

FIG. 15 is a diagram showing a case that an autonomous vehicle creates a branch point according to a second embodiment of the present invention. Particularly, FIG. 15 is a diagram to describe a processing method of a case that a branch point is located out of an area 1030 seen by a user riding in the autonomous vehicle 100.

Referring to FIG. 15, if detecting that an obstacle OB001 enters a second level route 1120 in a sensing area 1010, the processor of the autonomous vehicle 100 creates a branch point 1500.

In FIG. 15, unlike FIG. 14, since the branch point is located out of the area 1030 seen by the user riding in the autonomous vehicle 100, the processor of the autonomous vehicle 100 does not stop the autonomous vehicle 100 immediately but makes a request for an updated first level route 1510 different from the first level route 1110 to the server.

In response to the request, the processor of the autonomous vehicle 100 receives the first level route 1510 different from the first level route 1110, which was received at a first timing, at a second timing different from the first timing from the server. Subsequently, the processor of the autonomous vehicle 100 creates a second level route 1520 based on the first level route 1510 received at the second timing and sensing information.

The processor of the autonomous vehicle 100 controls the autonomous vehicle 100 to drive along the new second level route 1520 by changing a moving direction at the branch point 1500.

Meanwhile, as described in FIG. 13, the processor of the autonomous vehicle 100 compares a first time taken for the autonomous vehicle 100 to arrive at the branch point 1500 with a second time taken to create the second level route 1520 based on the first level route 1510 received at the second timing. And, the processor of the autonomous vehicle 100 determines whether to maintain a current speed of the autonomous vehicle 100 based on a result of the comparison.

Subsequently, like the step 1320 of FIG. 13, if the first time is shorter than the second time, the processor of the autonomous vehicle 100 decelerates the autonomous vehicle 100 by controlling the brake input device 570. On the contrary, if the first time is longer than the second time, the processor of the autonomous vehicle 100 controls the autonomous vehicle 100 to maintain a current speed.

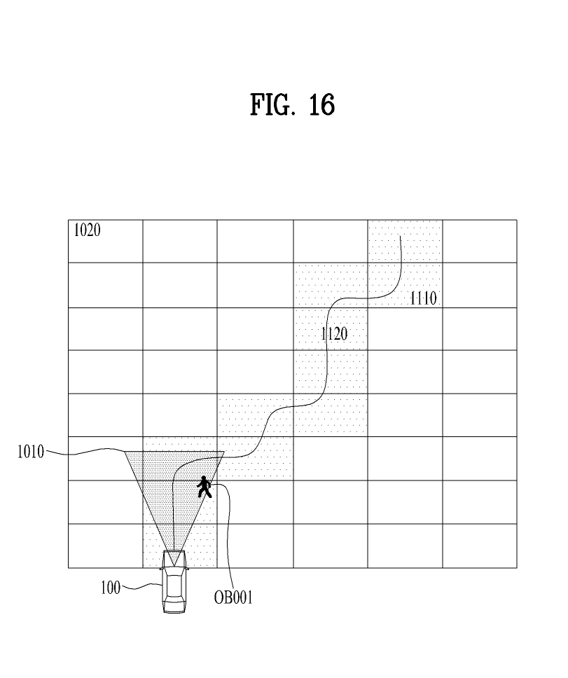

FIG. 16 is a diagram showing a case that an autonomous vehicle does not create a branch point according to a second embodiment of the present invention.

Referring to FIG. 16, if detecting that an obstacle OB001 enters a first level route 1110 in a sensing area 1010, the processor of the autonomous vehicle 100 does not create a branch point.

As described in FIG. 11, the first level route 1110 corresponds to rough information of a route to a specific parking slot, which is received from the server. Hence, if the obstacle OB001 enters the first level route 1110 in the sensing area 1010, it does not affect an actual moving track of the autonomous vehicle 100. Hence, the processor of the autonomous vehicle 100 does not create a branch point but controls the autonomous vehicle 100 to drive along a previously created second level route 1120.

Yet, by considering possibility of collision with the obstacle OB001, the processor of the autonomous vehicle 100 can control the brake input device 570 to decelerate the autonomous vehicle 100.

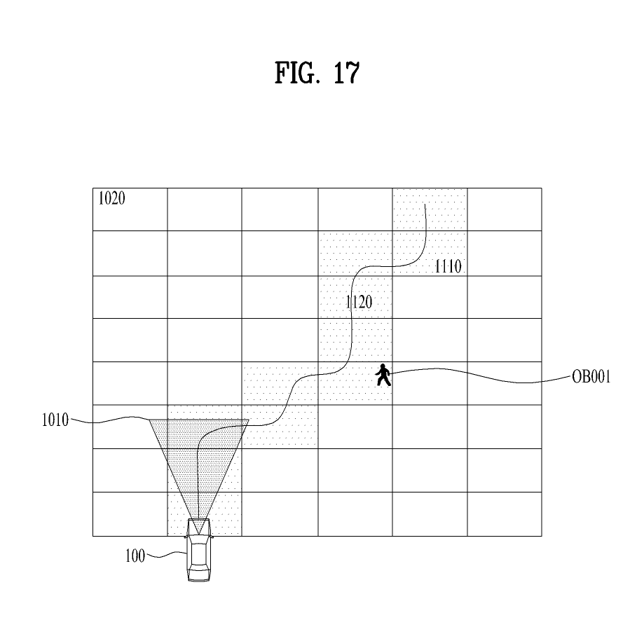

FIG. 17 is a diagram showing a case that an autonomous vehicle does not create a branch point according to a second embodiment of the present invention.

Referring to FIG. 17, according to the context similar to that of FIG. 16, if receiving information indicating that an obstacle OB001 enters a first level route 1110 in a communication coverage area 1020 from the server through the communication device 400, the processor of the autonomous vehicle 100 does not create a branch point.

In FIG. 17, since the obstacle OB001 is located out of a sensing area 1010 of the autonomous vehicle 100, the processor of the autonomous vehicle 100 is unable to directly detect the obstacle OB001 through the object detecting device 300. Hence, the processor of the autonomous vehicle 100 receives information indicating that the obstacle OB001 enters the first level route 1110 within the communication coverage area 1020 from the server through the communication device 400.

Like FIG. 16, if the obstacle OB001 enters the first level route 1110 in the communication coverage area 1020, it does not affect an actual moving track of the autonomous vehicle 100. Hence, the processor of the autonomous vehicle 100 does not create a branch point but controls the autonomous vehicle 100 to drive along a previously created second level route 1120.

### Third Embodiment

A third embodiment of the present invention relates to a case that an obstacle enters a second level route within a communication coverage area. Namely, the third embodiment relates to a method for a processor of an autonomous vehicle to process a case that an obstacle will possibly affect a moving track of the processor of the autonomous vehicle in the future despite not affecting the moving track of the processor of the autonomous vehicle for now.

FIG. 18 is a flowchart showing a method of controlling an autonomous vehicle according to a third embodiment of the present invention. Steps 1810 and 1820 of FIG. 18 may be performed after the step 850 of FIG. 8.

According to a step 1810 of FIG. 18, a processor of an autonomous vehicle receives information indicating that an obstacle enters a second level route in a communication coverage area from a server through a communication device. The second level route in the communication coverage area corresponds to a track on which the processor of the autonomous vehicle will move forward.

According to a step 1820 of FIG. 18, the processor of the autonomous vehicle sends information on at least one of a current location of the autonomous vehicle, a first level route and the second level route to the obstacle by communication with the server.

Meanwhile, the step 1820 of FIG. 18 may be performed if the obstacle fails to disappear from the second level route in the communication coverage area after expiration of a preset time (e.g., 10˜20 seconds) after completion of the step 1810.

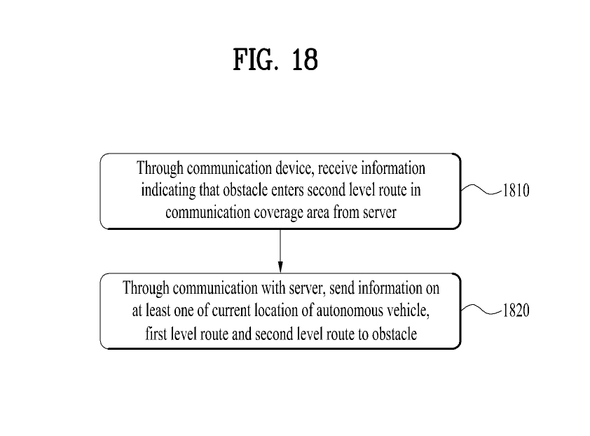

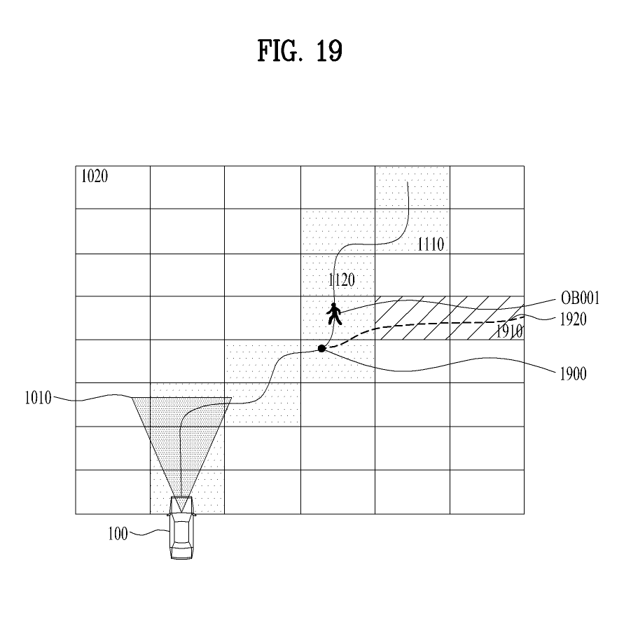

FIG. 19 is a diagram showing that an autonomous vehicle transceives information with an obstacle according to a third embodiment of the present invention.

Referring to FIG. 19, through the communication device 400, the processor of the autonomous vehicle 100 receives information indicating that an obstacle OB001 enters a second level route 1120 in a communication coverage area 1020 from a server. Since the obstacle OB001 does not affect a moving track of the autonomous vehicle 100 for now, the processor of the autonomous vehicle 100 does not create a branch point.

Yet, as the second level route 1120 in the communication coverage area 1020 entered by the obstacle OB001 corresponds to a track on which the autonomous vehicle 100 will move forward, the processor of the autonomous vehicle 100 sends information on at least one of a current location of the autonomous vehicle 100, a first level route 1110 and the second level route 1120 to the obstacle OB001 by communication with the server.

If the obstacle OB001 is a person (pedestrian), the processor of the autonomous vehicle 100 controls a visual or auditory warning message to be outputted from a facility located in a prescribed distance from the obstacle OB001 by communication with the server, thereby requesting the obstacle OB001 to move.

Or, if the obstacle OB001 is a vehicle (or an autonomous vehicle) equipped with a communication device, the processor of the autonomous vehicle 100 directly sends information on at least one of a current location of the autonomous vehicle 100, the first level route 1110 and the second level route 1120 to the obstacle OB001 by communication with the server, thereby requesting the obstacle OB001 to move.

Meanwhile, the processor of the autonomous vehicle 100 according to the third embodiment of the present invention can be designed to send the information on at least one of a current location of the autonomous vehicle 100, the first level route 1110 and the second level route 1120 to the obstacle OB001 only if the obstacle OB001 does not disappear from the second level route 1120 in the communication coverage area 1020 after expiration of a preset time (e.g., 10˜20 seconds) from a timing of receiving the information indicating that the obstacle OB001 enters the second level route 1120 in the communication coverage area 1020 from the server.

Meanwhile, by a method similar to that described in FIG. 14 or FIG. 15, the processor of the autonomous vehicle 100 can create a branch point 1900 under a specific condition. Namely, if the obstacle OB001 does not disappear from the second level route 1120 despite that the information on at least one of the current location of the autonomous vehicle 100, the first level route 1110 and the second level route 1120 to the obstacle OB001 is sent to the obstacle OB001, the processor of the autonomous vehicle 100 can create the branch point 1900.

If the branch point 1900 is created, the processor of the autonomous vehicle 100 makes a request for an update first level route 1910 different from the first level route 1110 to the server. In response to the request, the processor of the autonomous vehicle 100 receives the first level route 1910 from the server. Subsequently, based on the first level route 1910 and sensing information, the processor of the autonomous vehicle 100 creates a second level route 1920. The processor of the autonomous vehicle 100 controls the autonomous vehicle 100 to drive along the new second level route 1920 by changing an existing moving direction at the branch point 1900.

### Fourth Embodiment

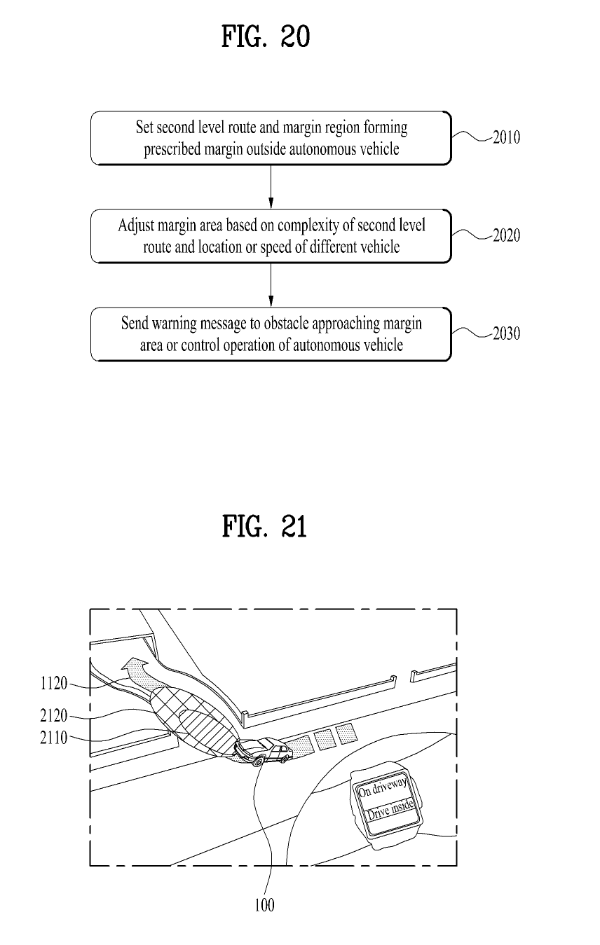

FIG. 20 is a flowchart showing a method of controlling an autonomous vehicle according to a fourth embodiment of the present invention. An autonomous vehicle according to a fourth embodiment of the present invention can set a virtual area forming a prescribed margin outside the vehicle. The area is adaptively adjusted according to internal and external conditions of the autonomous vehicle and becomes a factor for determining whether to communicate with a different vehicle. Such a virtual area may be referred to as a geofence. Meanwhile, in the description of the fourth embodiment of the present invention, ‘obstacle’ and ‘different vehicle’ can be construed as the same meaning.

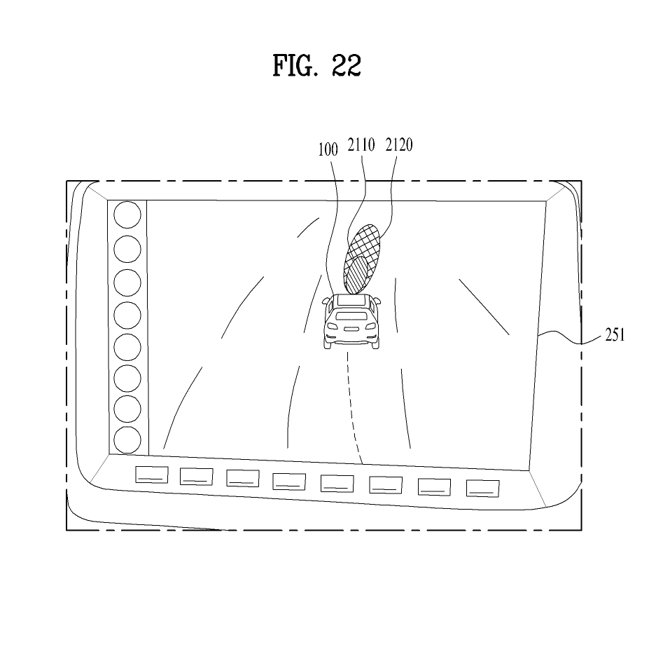

First of all, like a step 2010 of FIG. 20, the processor of the autonomous vehicle 100 sets a second level route and a margin area that forms a prescribed margin outside the autonomous vehicle. And, the processor of the autonomous vehicle 100 outputs the margin area through the output unit 250 shown in FIG. 7. Particularly, the margin area can be outputted through the display 251 of the output unit 250. This shall be described in FIG. 22.

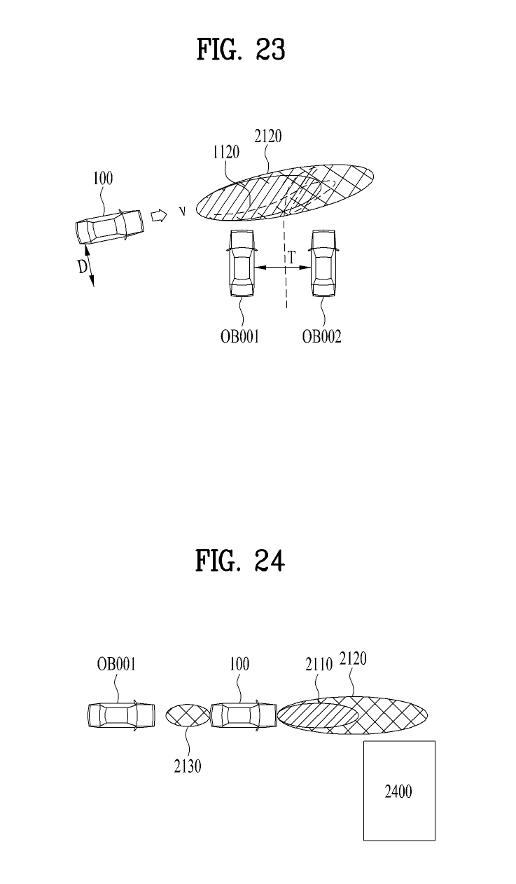

Subsequently, like a step 2020 of FIG. 20, the processor of the autonomous vehicle 100 adjusts the margin area based on complexity of the second level route and a location or speed of a different vehicle. A process for the processor of the autonomous vehicle 100 to adjust the margin area shall be described in detail with reference to FIG. 23 and FIG. 24.

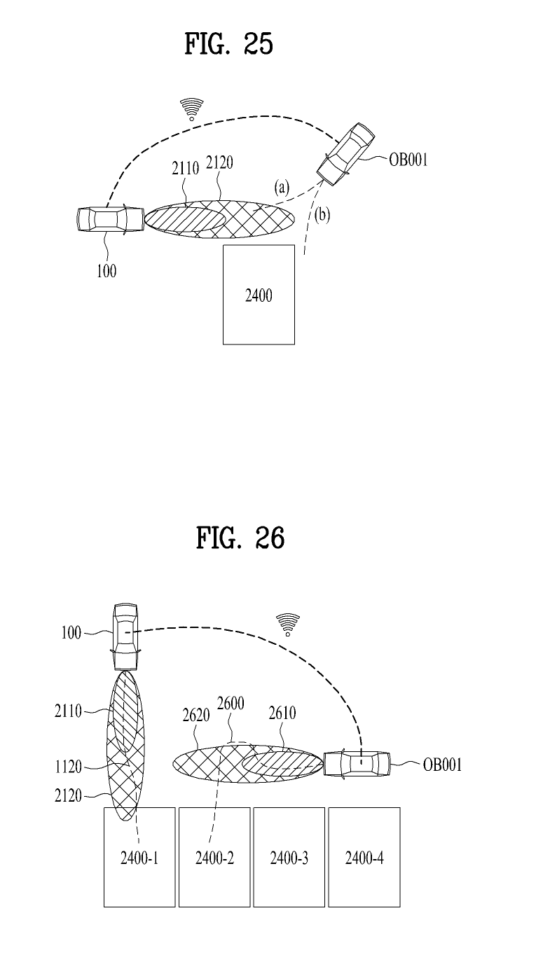

Like a step 2030 of FIG. 20, the processor of the autonomous vehicle 100 sends a warning message to an obstacle approaching the margin area or controls an operation of the autonomous vehicle 100. A process for the processor of the autonomous vehicle 100 to send a warning message to an obstacle approaching the margin area or control an operation of the autonomous vehicle 100 shall be described in detail with reference to FIG. 25 and FIG. 26.

FIG. 21 is a diagram showing a margin area of an autonomous vehicle according to a fourth embodiment of the present invention. The following description shall be made on the assumption that the autonomous vehicle 100 creates a second level route 1120 to a specific parking slot according to the first embodiment of the present invention.

Referring to FIG. 21, the processor of the autonomous vehicle 100 sets a second level route 1120 and a margin area forming a prescribed margin outside the autonomous vehicle 100. The margin area may include a first margin area 2110 and a second margin area 2120.

The first margin area 2110 is an area forming a prescribed margin by including the second level route 1120 of the autonomous vehicle 100. The margin may have a value such as 5 m, 10 m or the like as a radius from the autonomous vehicle 100. And, the margin may be determined on manufacturing the autonomous vehicle 100 or adjusted by a user.

The second margin area 2120 contains the first margin area 2110, forms a prescribed margin, and is an area set to send a warning message in case that such an obstacle as a different vehicle approaches.

Meanwhile, through an external device (e.g., smart watch) interworking with the autonomous vehicle 100, the processor of the autonomous vehicle 100 can inform a user wearing the external device that an obstacle enters the first margin area 2110 or the second margin area 2120.

FIG. 22 is a diagram showing that a margin area of an autonomous vehicle 100 according to a fourth embodiment of the present invention is outputted through an output unit.

As described in FIG. 7, the output unit 250 of the autonomous vehicle 100 generates a visual, auditory or tactile signal, thereby delivering information to a user. The output unit 250 may include at least one of the display unit 251, the audio output unit 252 and the haptic output unit 253. Particularly, the display unit 251 can display a graphic object responding to various information.

The processor of the autonomous vehicle 100 can control a current location of the autonomous vehicle 100, an ambient situation, a first margin area 2110 and a second margin area 2120 to be outputted to the display unit 251. Through visual information outputted to the display unit 251, a user can easily check an obstacle approaching the first margin area 2110 and the second margin area 2120.

FIG. 23 is a diagram showing that a processor of an autonomous vehicle according to a fourth embodiment of the present invention adjusts a margin area.

Referring to FIG. 23, the processor of the autonomous vehicle 100 according to the fourth embodiment of the present invention can adjust a second margin area 2120 based on complexity of a second level route 1120. The second margin area 2120 can be defined as Formula 1.

f(v_{ego})+g(NOI)+Σₜ₌₁^{N}h(v_{di})+Σₜ₌₁^{N}κ(r_{di}) [Formula 1]

In Formula 1, means a speed of the autonomous vehicle 100 and N (Number of Iteration) means a repetition count in aspect of creation of the second level route 1120 in the course of performing a parking process. v_{di} means a speed of an i^{th} detected different vehicle, and r_{di} means a relative distance from the i^{th} detected different vehicle.

The higher complexity of the second level route 1120 gets, the wider the second margin area 2120 can be set by the processor of the autonomous vehicle 100 according to the fourth embodiment of the present invention. The processor of the autonomous vehicle 100 can determine the complexity of the second level route 1120 based on at least one of a forward or backward repetition count of the autonomous vehicle, steering wheel manipulation information, and a distance from a parking slot. A forward or a backward repetition count of the autonomous vehicle means the number of times the autonomous vehicle moves forwardly or backwardly in a parking process.

For example, if the forward or backward repetition count for the autonomous vehicle 100 to arrive at the parking slot is equal to or greater than a prescribed count, if the autonomous vehicle 100 passes through a same location in a prescribed time over a prescribed count, if the steering wheel of the autonomous vehicle 100 is changed over a prescribed count, or if the autonomous vehicle 100 enters a range of a prescribed distance from the parking slot, the processor of the autonomous vehicle 100 can determine that the complexity of the second level route 1120 is high.

If the complexity of the second level route increases higher, it is necessary to secure sufficient time to prevent collisions with different vehicles OB0001 and OB002. Hence, the processor of the autonomous vehicle 100 can set the second margin area 2120 to be wider.

FIG. 24 is a diagram showing that a processor an autonomous vehicle according to a fourth embodiment of the present invention further sets a third margin area. A processor of an autonomous vehicle determines at least one of a location, an approach direction and a speed of an obstacle approaching a third margin area and is then able to control an operation of the autonomous vehicle based on the determination.

Unlike FIG. 23, a margin area may be set in rear of the autonomous vehicle 100. Particularly, a third margin area 2130 set in rear of the autonomous vehicle 100 can be set based on a location and/or speed of a different vehicle OB001. The third margin area 2130 can be defined as Formula 2.

f(TTC)+g(rᵣₑₐᵣ) [Formula 2]

In Formula 2, TTC (Time to Collision) means an estimated collision time between the different vehicle OB001 and the autonomous vehicle 100 and means a distance between the different vehicle OB001 and the autonomous vehicle 100.

When the different vehicle OB001 is running in rear of the autonomous vehicle 100 in the same direction of the autonomous vehicle 100, a processing method of the processor of the autonomous vehicle 100 is described with reference to FIG. 24 as follows.

When the different vehicle OB001 enters the third margin area 2130, the processor of the autonomous vehicle 100 according to the fourth embodiment of the present invention can flicker emergency light to inform the different vehicle OB001 of a parking start of the autonomous vehicle 100. Hence, it is able to secure a physical distance between the autonomous vehicle 100 and the different vehicle OB001.

Or, when the different vehicle OB001 enters the third margin area 2130, if the different vehicle OB001 is a vehicle capable of communication, the processor of the autonomous vehicle 100 according to the fourth embodiment of the present invention may send a warning message by performing vehicle-to-vehicle communication.

On the other hand, if a different vehicle OB001 approaches toward the autonomous vehicle 100 from an opposite side of the autonomous vehicle 100, the processor of the autonomous vehicle 100 flickers emergency light. Furthermore, if the different vehicle OB001 is a vehicle capable of communication, the processor of the autonomous vehicle 100 may send a warning message by performing vehicle-to-vehicle communication.

FIG. 25 is a diagram showing that a processor of an autonomous vehicle according to a fourth embodiment of the present invention controls an operation of the autonomous vehicle based on a running characteristic or intention of a different vehicle. The running characteristic or intention of the different vehicle may include at least one of a location, approach direction and speed of the different vehicle.

The processor of the autonomous vehicle 100 according to the fourth embodiment of the present invention can determine whether a different vehicle OB001 is a vehicle that will interrupt a parking process of the autonomous vehicle 100 by a following method.

First of all, the processor of the autonomous vehicle 100 directly receives information on the running characteristic or intention of the different vehicle OB001 using vehicle-to-vehicle (V2V) communication through the communication device 400, thereby determining at least one of a location, approach direction and speed of the different vehicle OB001.

Referring to FIG. 25, if determining that the different vehicle OB001 will run on a route (a) based on the received information, the processor of the autonomous vehicle 100 can directly send the different vehicle OB001 information on at least one of a target parking slot 2400 and a first margin area 2110 of a second margin area 2120 of the autonomous vehicle 100. On the other hand, if determining that the different vehicle OB001 will run on a route (b) based on the received information, the processor of the autonomous vehicle 100 can continue to park at the target parking slot 2400 without sending information to the different vehicle OB001.

Secondly, the processor of the autonomous vehicle 100 learns an action pattern of a moving obstacle using a deep neural network beforehand and then estimates a running characteristic or intention of the different vehicle based on the learned action pattern, thereby determining at least one of a location, approach direction and speed of the different vehicle OB001. This is the method that can be performed if V2V communication through the communication device 400 is not available.

Meanwhile, if determining that the different vehicle OB001 will be driven on the route (b) through the aforementioned two kinds of methods, when the different vehicle OB001 or a moving track of the different vehicle OB001 overlaps with the second margin area 2120 in part, the processor of the autonomous vehicle 100 according to the fourth embodiment of the present invention does not send a warning message to the different vehicle OB001. Only if the different vehicle OB001 or a moving track of the different vehicle OB001 overlaps with the first margin area 2110, the processor of the autonomous vehicle 100 according to the fourth embodiment of the present invention can send a warning message to the different vehicle OB001.

FIG. 26 is a diagram showing that a processor of an autonomous vehicle 100 according to a fourth embodiment of the present invention creates a parking track using vehicle-to-vehicle communication.

Referring to FIG. 26, if a plurality of parking slots 2400-1 to 2400-4 available for parking exist and the autonomous vehicle 100 is able to communicate with a different vehicle OB001, the processor of the autonomous vehicle 100 can receive information of at least one of a parking track 2600, a first margin area 2610 and a second margin area 2620 of the different vehicle OB001 from the different vehicle OB001 by V2V communication.

Through the received information, the processor of the autonomous vehicle 100 can create a parking track 1120 that does not overlap with the parking track 2600, the first margin area 2610 or the second margin area 2620 of the different vehicle OB001.

The processor of the autonomous vehicle 100 sends information of at least one of the created parking track 1120, a first margin area 2110 and a second margin area 2120 to the different vehicle OB001, thereby preventing collision in advance.

Meanwhile, referring to FIG. 26, the processor of the autonomous vehicle 100 according to the fourth embodiment of the present invention can be designed to perform a process for parking in a parking slot 2400-1 under the condition that the second margin area 2620 of the different vehicle OB001 and the second margin area 2120 of the autonomous vehicle 100 do not overlap with each other.

The above-described present invention can be implemented in a program recorded medium as computer-readable codes. The computer-readable media may include all kinds of recording devices in which data readable by a computer system are stored. The computer-readable media may include HDD (hard disk drive), SSD (solid state disk), SDD (silicon disk drive), ROM, RAM, CD-ROM, magnetic tapes, floppy discs, optical data storage devices, and the like for example and also include carrier-wave type implementations (e.g., transmission via Internet). Further, the computer may include a processor or a controller. It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A driver assist apparatus, comprising:
an interface device electrically connected to at least one object detecting device on an autonomous vehicle, and a communication device;
at least one processor; and
a non-transitory computer-readable medium coupled to the at least one processor having stored thereon instructions which, when executed by the at least one processor, causes the at least one processor to perform operations comprising:
transmitting, through the communication device to a server, a request for parking slot information;
receiving, through the communication device from the server, the parking slot information;
selecting, by a user of the autonomous vehicle or by the at least one processor, a target parking slot based on the parking slot information;
receiving, through the communication device from the server at a first time, a first level route from a current location of the autonomous vehicle to the target parking slot;
generating a second level route based on (i) sensing information in a sensing area of the object detecting device and (ii) the first level route; and
controlling the autonomous vehicle to drive to the target parking slot based on the second level route.

2. The driver assist apparatus of claim 1, wherein a communication coverage area of the communication device comprises the first level route.

3. The driver assist apparatus of claim 2, wherein the first level route comprises the second level route.

4. The driver assist apparatus of claim 3, wherein the operations comprise:
determining, through the object detecting device or the communication device, a location of an obstacle; and
based on the location of the obstacle, determining whether to create a branch point on the second level route.

5. The driver assist apparatus of claim 4, wherein determining the location of the obstacle comprises:
detecting, through the object detecting device, the obstacle within the sensing area of the object detecting device, and
wherein determining whether to create a branch point on the second level route comprises:
determining that the obstacle is located (i) within the sensing area of the object detecting device and (ii) on the first level route; and
based on the determination that the obstacle is located (i) within the sensing area of the object detecting device and (ii) on the first level route, maintaining the second level route.

6. The driver assist apparatus of claim 4, wherein determining the location of the obstacle comprises:
detecting, through the object detecting device, the obstacle within the sensing area of the object detecting device, and
wherein determining whether to create a branch point on the second level route comprises:
determining that the obstacle is located (i) within the sensing area of the object detecting device and (ii) on the second level route; and
based on the determination that the obstacle is located (i) within the sensing area of the object detecting device and (ii) on the second level route, creating a branch point.

7. The driver assist apparatus of claim 6, wherein the operations comprise:
based on the creation of the branch point, generating a detour route between the branch point and a point along the second level route, the detour route being configured to avoid the obstacle.

8. The driver assist apparatus of claim 6, wherein the operations comprise:
receiving, through the communication device from the server at a second time, an updated first level route from the current location of the autonomous vehicle to the target parking slot; and
generating an updated second level route based on the updated first level route, wherein the second time is different from the first time.

9. The driver assist apparatus of claim 4, wherein determining the location of the obstacle comprises:
receiving, through the communication device, information comprising the location of the obstacle, and
wherein the operations comprise:
determining that the obstacle is located on the second level route; and
based on the determination that the obstacle is located on the second level route, transmitting, through the communication device to the server, information to be provided to the obstacle, the information comprising at least one of the current location of the autonomous vehicle, the first level route, or the second level route.

10. The driver assist apparatus of claim 9, wherein the obstacle is a vehicle, and the information to be provided to the obstacle is communicated by the server to the obstacle, or
wherein the obstacle is a person, and the information to be provided to the obstacle is displayed on a facility located within a prescribed distance from the obstacle.

11. The driver assist apparatus of claim 8, wherein the operations comprise:
determining a first duration for the autonomous vehicle to travel between the current location of the autonomous vehicle and the branch point based on a current speed of the autonomous vehicle;
determining a second duration for the at least one processor to generate the updated second level route;
determining whether the first duration is longer than the second duration; and
based on a determination of whether the first duration is longer than the second duration, controlling the current speed of the autonomous vehicle.

12. The driver assist apparatus of claim 11, wherein controlling the current speed of the autonomous vehicle comprises:
based on a determination that the first duration is shorter than or equal to the second duration, decelerating the autonomous vehicle; and
based on a determination that the first duration is longer than the second duration, maintaining the current speed of the autonomous vehicle.

13. The driver assist apparatus of claim 1, wherein the operations comprise:
setting a margin area external to the autonomous vehicle; and
outputting, through an output unit of the autonomous vehicle, the margin area.

14. The driver assist apparatus of claim 13, wherein the margin area comprises:
a first margin area comprising at least a portion of the second level route of the autonomous vehicle; and
a second margin area comprising the first margin area and at least a portion of the first level route.

15. The driver assist apparatus of claim 13, wherein the operations comprise:
determining a complexity of the second level route; and
adjusting the margin area based on the complexity.

16. The driver assist apparatus of claim 15, wherein the determination of the complexity of the second level route is based on at least one of:
a forward or a backward repetition count of the autonomous vehicle;
steering wheel manipulation information; or
a distance between the current location of the autonomous vehicle and the target parking slot.

17. The driver assist apparatus of claim 13, wherein the operations comprise:
determining at least one of a location, an approach direction, or a speed of an obstacle approaching the margin area; and
controlling an operation of the autonomous vehicle based on the determined at least one of the location, the approach direction, or the speed of the obstacle approaching the margin area.

18. The driver assist apparatus of claim 17, wherein determining at least one of the location, the approach direction, or the speed of the obstacle approaching the margin area comprises:
receiving, from the obstacle through the communication device, information associated with a running characteristic or an intention of the obstacle; and
determining at least one of the location, the approach direction, or the speed of the obstacle approaching the margin area based on the information associated with the running characteristic or the intention.

19. The driver assist apparatus of claim 17, wherein determining at least one of the location, the approach direction, or the speed of the obstacle approaching the margin area comprises:
estimating a running characteristic or an intention of the obstacle based on a previously learned action pattern of a moving obstacle; and
determining at least one of the location, the approach direction, or the speed of the obstacle approaching the margin area based on the estimated running characteristic or the estimated intention.

20. A method of controlling a driver assist apparatus, comprising:
transmitting, through a communication device of the autonomous vehicle to a server, a request for parking slot information;
receiving, through the communication device from the server, the parking slot information;
selecting, by a user of the autonomous vehicle or by an at least one processor of the autonomous vehicle, a target parking slot based on the parking slot information;
receiving, through the communication device from the server at a first time, a first level route from a current location of the autonomous vehicle to the target parking slot;
generating a second level route based on (i) sensing information in a sensing area of an object detecting device of the autonomous vehicle and (ii) the first level route; and
controlling the autonomous vehicle to drive to the target parking slot based on the second level ro
